(19) United States
(12) Patent Application Publication
(10) Pub. No.: US 2016/0156793 A1
(43) Pub. Date: Jun. 2, 2016

(54) OPERATION DISPLAY APPARATUS AND INPUT METHOD THERETO

(71) Applicant: KYOCERA Document Solutions Inc., Osaka (JP)

(72) Inventor: Yoshifumi OKABAYASHI, Osaka (JP)

(73) Assignee: KYOCERA Document Solutions Inc., Osaka (JP)

(21) Appl. No.: 14/953,332

(22) Filed: Nov. 28, 2015

(30) Foreign Application Priority Data
Nov. 28, 2014 (JP) 2014-241798

(51) Int. Cl. H04N 1/00; G06F 3/0488; H04N 1/44; G06F 3/041

(52) U.S. Cl. CPC H04N 1/00392; G06F 3/0412; G06F 3/0416; G06F 3/0488; H04N 1/00474; H04N 1/00482; H04N 1/442; G06F 2203/04104; H04N 2201/0094

(57) ABSTRACT

Provided is an image-forming apparatus and an input method capable of inputting numerical values quickly and easily without providing a hardware ten-key or causing an operation display part to display a software ten-key. The image-forming apparatus includes a display part (IP), a touch panel (TP), and a control part (CP). The IP indicates various information pieces (VIP) including an indicated numerical value (INV) to be inputted on a plane. The TP provided on a surface of the IP detects a position to which an operation, say, a depression is made for operating each of different operation points. The CP receives detection information from the TP and outputs the VIP to the IP. The CP counts the number of tapping actions as the INV, each the tapping action being an operation on a first operation point within a first detection region on the TP.

### INCORPORATION BY REFERENCE

This application is based on and claims the benefit of priority from Japanese Patent Application No. 2014-241798 filed on Nov. 28, 2014, the contents of which are hereby incorporated by reference.

### BACKGROUND

The present disclosure relates to an operation display apparatus and an input method thereto, the operation display apparatus being configured to include a display apparatus such as a touch panel and an input apparatus, the operation display apparatus being configured to receive information pieces that include the number of sheets from the input apparatus at an initial stage of a process. The present disclosure also pertains to an input method for inputting the information pieces to the preceding operation display apparatus.

Hardware products such as copiers involving frequent numerical inputs are provided with, other than a touch panel, a ten-key pad. That is to say, when numerical values are required to be inputted, depressing the ten-key pad will complete the inputs of object numerical values.

However, products without a ten-key pad are increasing. In such a case, instead of the hardware ten-key pad, the touch panel causes a ten-key as a software keyboard to appear thereon. Then, inputting operations are made by way of the touch panel (software key board).

However, in such a case, an area of the touch panel is occupied largely with the software keyboard. In addition, for causing a portion of the touch panel which is usually indicative of other information pieces to display the software keyboard, it is necessary to provide a separate button switch (hardware switch). Thus, it is difficult to say that such a configuration is user friendly.

### SUMMARY

An operation display apparatus according to an exemplary embodiment of the present disclosure includes a display part, a touch panel, and a control part. The display part is capable of displaying, on a plane, various information pieces that include an indicated numerical value to be inputted. The touch panel is provided on a surface of the display part and capable of detecting a position to which an operation such as a depression is made for operating each of different plural operation points. The control part is configured to receive a detection information piece from the touch panel and outputs the various information pieces to the display part. The control part is, then, configured to count the number of tapping actions as the indicated numerical value, each of the tapping actions being an operation on a first operation point within a first detection region that is provided on the touch panel.

An input method according to an exemplary embodiment of the present disclosure is an input method for use in conjunction with an image forming apparatus. The image forming apparatus includes a display part and a touch panel. The display part is capable of displaying, on a plane, various information pieces that include an indicated numerical value to be inputted. The touch panel is provided on a surface of the display part and is capable of detecting a position to which an operation such as a depression is made for operating each of different plural operation points. The number of tapping actions as the indicated numerical value is counted, each of the tapping actions being operation on a first operation point within a first detection region that is provided on the touch panel. “n” is detected that is indicative of the number of second operation points that are to be operated within a second detection region, the second detection region being provided on the touch panel so as to be positioned in the vicinity of the first detection region. The number of tapping actions at (n+1)th digit of the indicated numerical value is counted. An operation on a third operation point within a third operation region is detected, the third detection region being provided on the touch panel so as to be positioned in the vicinity of the first detection region and in the vicinity of the second detection region. It is caused that, in a case while the third operation point is determined not to be operated, the indicated numerical value to increase by a specific value every time the tapping action on the first operation point is detected. It is caused that in a case while the third operation point is determined to be operated, the indicated numerical value to decrease by a specific value every time the tapping action on the first operation point is detected.

### BRIEF DESCRIPTION OF THE DRAWINGS

FIG. 1 is an illustration of an exemplary overall configuration of an MFP 11 according to an exemplary embodiment of the present disclosure;

FIG. 2 is an illustration of an exemplary electrical configuration of the MFP 11 according to the exemplary embodiment of the present disclosure;

FIG. 3A is an illustration of a display example of an LCD140a in the exemplary embodiment of the present disclosure;

FIG. 3B is an illustration of a display example of the LCD140a in the exemplary embodiment of the present disclosure;

FIG. 3C is an illustration of a display example of the LCD140a in the exemplary embodiment of the present disclosure;

FIG. 4A is an illustration that is descriptive of how to recognize a palm 31R of a user 30's hand 31R in the exemplary embodiment of the present disclosure;

FIG. 4B is another illustration that is descriptive of how to recognize the palm 31R of the user 30's hand 31R in the exemplary embodiment of the present disclosure;

FIG. 5A is an illustration in which are shown a display of an LCD 140a and a positional relationship between detection regions 140f-1 to 140f-3 in the exemplary embodiment of the present disclosure;

FIG. 5B is an illustration in which are shown a display of an LCD 140a and a positional relationship between detection regions 140f-1 to 140f-3 in the exemplary embodiment of the present disclosure;

FIG. 6 is a flowchart that is indicative of one cycle of a monitor procedure that monitors repeatedly operations applied to a touch panel 140b in the exemplary embodiment of the present disclosure;

FIG. 7A is an illustration that is indicative of a condition of an operation display part 140 when only the detection region 140f-1 is tapped in the exemplary embodiment of the present disclosure;

FIG. 7B is an illustration that is indicative of a condition of the operation display part 140 when only the detection region 140f-1 is tapped in the exemplary embodiment of the present disclosure;

FIG. 7C is an illustration that is indicative of a condition of the operation display part 140 when only the detection region 140f-1 is tapped in the exemplary embodiment of the present disclosure;

FIG. 8A is an illustration that is indicative of a condition of the operation display part 140 when the detection region 140f-2 is depressed by a single finger and the detection region 140f-1 is tapped in the exemplary embodiment of the present disclosure;

FIG. 8B is an illustration that is indicative of a condition of the operation display part 140 when the detection region 140f-2 is depressed by the single finger and the detection region 140f-1 is tapped in the exemplary embodiment of the present disclosure;

FIG. 8C is an illustration that is indicative of a condition of the operation display part 140 when the detection region 140f-2 is depressed by the single finger and the detection region 140f-1 is tapped in the exemplary embodiment of the present disclosure;

FIG. 9A is an illustration that is indicative of a condition of the operation display part 140 when the detection region 140f-2 is depressed by two fingers and the detection region 140f-1 is tapped in the exemplary embodiment of the present disclosure;

FIG. 9B is an illustration that is indicative of a condition of the operation display part 140 when the detection region 140f-2 is depressed by the two fingers and the detection region 140f-1 is tapped in the exemplary embodiment of the present disclosure;

FIG. 9C is an illustration that is indicative of a condition of the operation display part 140 when the detection region 140f-2 is depressed by the two fingers and the detection region 140f-1 is tapped in the exemplary embodiment of the present disclosure;

FIG. 10A is an illustration that is indicative of a condition of an operation display part 140 when the detection region 140f-3 is depressed and the detection region 140f-1 is tapped in the exemplary embodiment of the present disclosure;

FIG. 10B is an illustration that is indicative of a condition of the operation display part 140 when the detection region 140f-3 is depressed and the detection region 140f-1 is tapped in the exemplary embodiment of the present disclosure;

FIG. 10C is an illustration that is indicative of a condition of the operation display part 140 when the detection region 140f-3 is depressed and the detection region 140f-1 is tapped in the exemplary embodiment of the present disclosure;

FIG. 11A is an illustration that is indicative of an exemplary modification of the exemplary embodiment of the present disclosure in which a pattern is provided as a mark at a position corresponding to the detection region 140f-2;

FIG. 11B is an illustration that is indicative of an exemplary modification of the exemplary embodiment of the present disclosure in which a pattern is provided as a mark at a position corresponding to the detection region 140f-2;

FIG. 12A is an illustration that is indicative of an exemplary modification of the exemplary embodiment of the present disclosure in which an addition/subtraction direction is clearly indicated;

FIG. 12B is an illustration that is indicative of an exemplary modification of the exemplary embodiment of the present disclosure in which an addition/subtraction direction is clearly displayed;

FIG. 13A is an illustration that is indicative of an exemplary modification of the exemplary embodiment of the present disclosure in which an example display is shown when the touch panel 140b undergoes a sliding operation;

FIG. 13B is an illustration that is indicative of an exemplary modification of the exemplary embodiment of the present disclosure in which an example display is shown when the touch panel 140b undergoes a sliding operation;

FIG. 13C is an illustration that is indicative of an exemplary modification of the exemplary embodiment of the present disclosure in which an example display is shown when the touch panel 140b undergoes a sliding operation;

FIG. 13D is an illustration that is indicative of an exemplary modification of the exemplary embodiment of the present disclosure in which an example display is shown when the touch panel 140b undergoes a sliding operation;

FIG. 14A is an illustration that is indicative of an exemplary modification of the exemplary embodiment of the present disclosure in which an example display is shown when coping with a left-hand manipulation;

FIG. 14B is an illustration that is indicative of an exemplary modification of the exemplary embodiment of the present disclosure in which an example display is shown when coping with a left-hand manipulation;

FIG. 14C is an illustration that is indicative of an exemplary modification of the exemplary embodiment of the present disclosure in which an example display is shown when coping with a left-hand manipulation;

FIG. 15A is an illustration that is indicative of an exemplary modification of the exemplary embodiment of the present disclosure in which an example display is shown when a numeric display part and a tapping part (140n) are separated with each other; and

FIG. 15B is an illustration that is indicative of an exemplary modification of the exemplary embodiment of the present disclosure in which an example display is shown when a numeric display part and a tapping part (140n) are separated with each other.

### DETAILED DESCRIPTION

Next, exemplary embodiments of the present disclosure will be detailed with reference to the attached drawings. It is to be noted that the same reference codes refer to the same elements throughout the drawings.

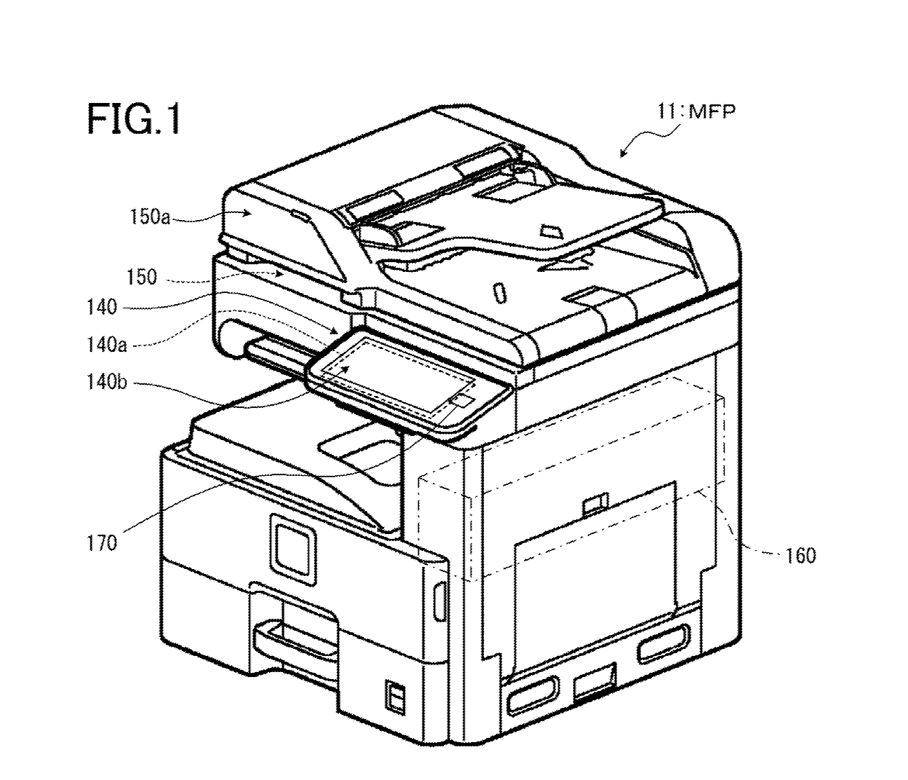

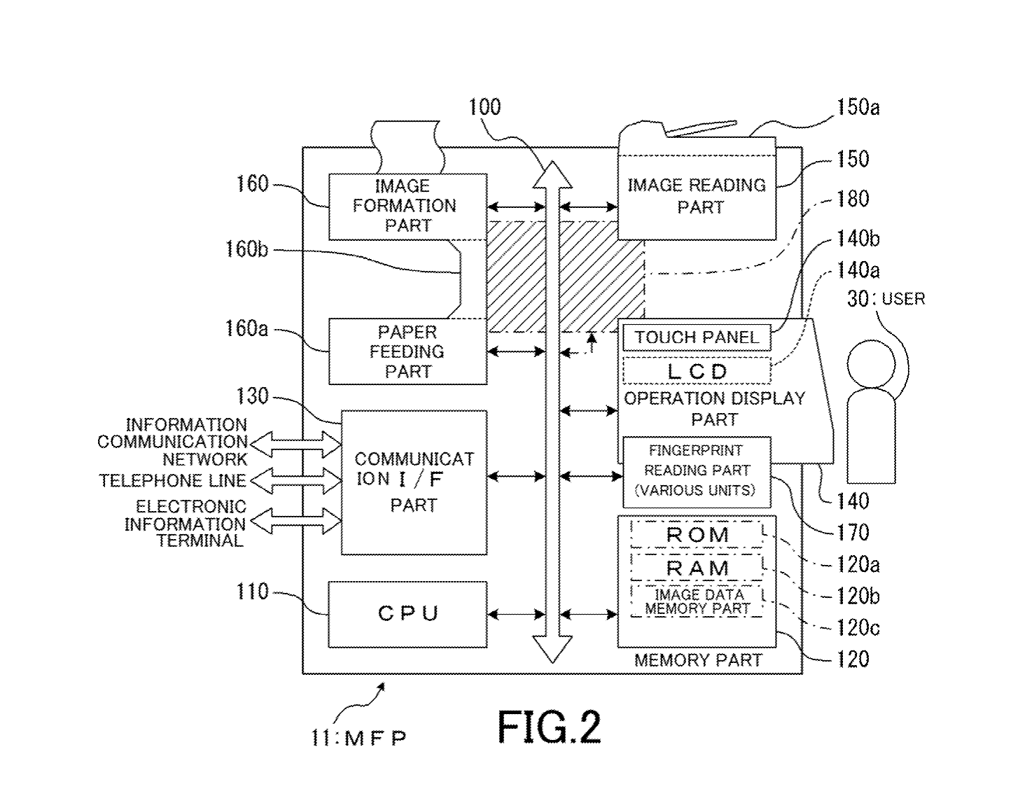

As illustrated in FIG. 1 (illustrating an overall configuration) and FIG. 2 (electrical configuration), an exemplary embodiment of the present disclosure provides a configuration in which a user 30 is allowed to manipulate an operation display part 140 that is provided on an MFP (Multi-Function Peripheral) 11 as an operation display device. The MFP is also called a combined apparatus in general.

The MFP 11 has a configuration in which a BUS 100 is connected with a CPU (Central Processing Unit) 11, a memory part 120, a communication I/F (Interface) part, an operation display part 140, an image reading part 150, an image forming part 160, a fingerprint reading part 170, a group 180 of various sensors, and other elements. In addition, the BUS 100 is also connected with various units that include, for example, a sorter.

The CPU 11 controls the whole of the MFP 11 based on operation programs that are stored previously on the memory part 120. The memory part 120 includes an image data memory part 120c. The image data memory part 120c uses a ROM (Read Only Memory) 120a as a non-volatile memory and also uses, as volatile memories, each RAM (Random Access Memory) 120b, a HDD (Hard Disk Drive), a flash memory, and the like. The flash memory is a kind of semiconductor memory device that is capable of being electrically rewritten.

The communication I/F part 130 is an interface that connects the MFP 11 to an external devices, a network, and the like. For example, the communication I/F part 130 is used to connect to an information communication network that comply with LAN (Local Area Network) protocols. In addition, the communication I/F part 130 includes a modem (MODulator DEModulator) as an interface that allows for a facsimile transceiving via a connected telephone. Furthermore, the communication includes, for being connected to an electronic information terminal, an IEEE1284 for parallel data transmission, a Universal Serial Bus for serial data transmission, and the like.

The operation display part 140 is made up of an LCD (Liquid Crystal Display) 140a, a touch panel 140b, and other components. This LCD 140a is configured to display various information pieces that will be described later. In addition, the touch panel 140b is manipulated by a user 30 while the user 30 looking at the LCD 140a.

The image reading part 150 reads an image of a manuscript or the like in an optical manner. An ADF 150a that serves for a manuscript reading device is located on the image reading part 150. The ADF 150a is configured to feed out manuscripts that are piled on one another, one by one, in a sequential manner and to convey the resulting manuscript D to an upper surface of the image reading part 150.

The image forming part 160 is in connection with a paper feeding part 160 in which a specific number of printing papers are accommodated via a paper carrying part 160b that is provided therebetween. This image forming part 160 is configured to record various results of operations of the CPU 110 on the printing papers or the like. These operation results include operation results of externally inputted image data piece.

Sensors that make up of the sensor group 180 are provided to the operation display part 140, the image reading part 150, and the image forming part 160. The sensor group 180 may be included in the various units. The sensor group 180 monitors a process of each the parts. When the sensor group 180 detects heat generation and vibration, the sensor group 180 sends the resulting signals to the CPU 110.

It is to be noted that detailing a configuration of the sensor group 180 and the signals issued therefrom are omitted in the description of the exemplary embodiment of the present disclosure.

The MFP 11 in the exemplary embodiment of the present disclosure are to be in receipt of many instructions and manipulations. These instructions and manipulations include manipulations for copying process, manipulations for facsimile transceiving operation or scanning operation, and manipulations an operation for printing operation.

It is to be noted that the manipulations for copying process include, for example, a specification of the number of sheets to be copied. In addition, the facsimile transceiving is to transmit a document that the image reading part 150 reads. Other functions of the facsimile transceiving include, for example, taking out a received facsimile data piece. The manipulations for scanning operation include, for example, an instruction to start reading a manuscript. Furthermore, the manipulations for printing include, for example, a selection and designation of a sheet size of the paper.

In the exemplary embodiment of the present disclosure presupposes that these instructions and manipulations are made by way of the touch panel 140a of the operation display part 140.

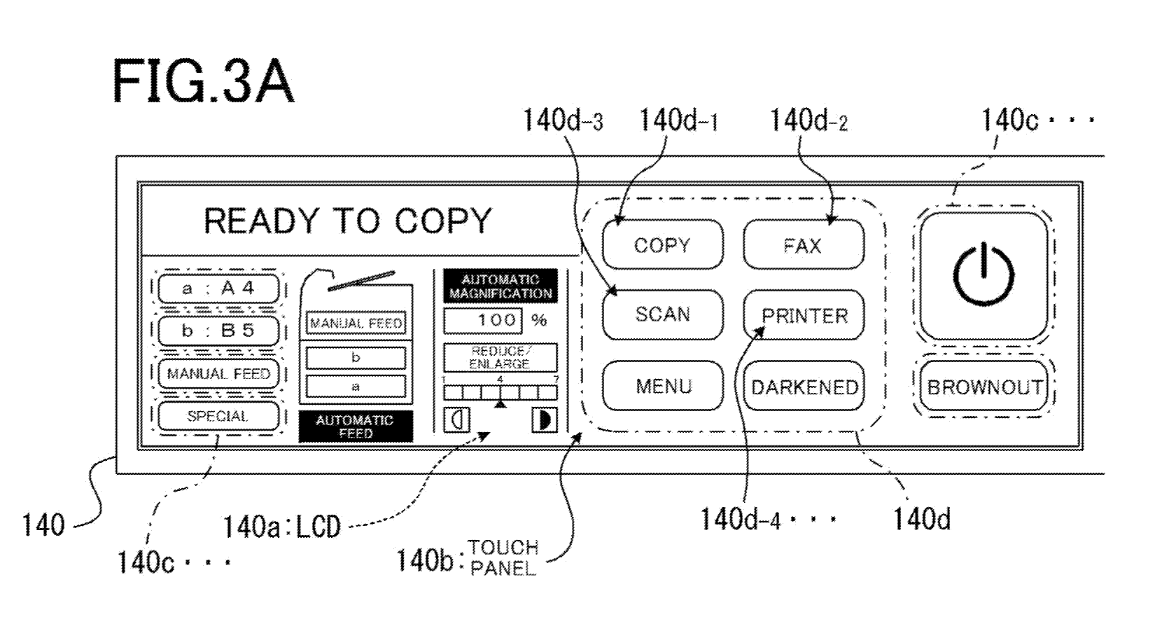

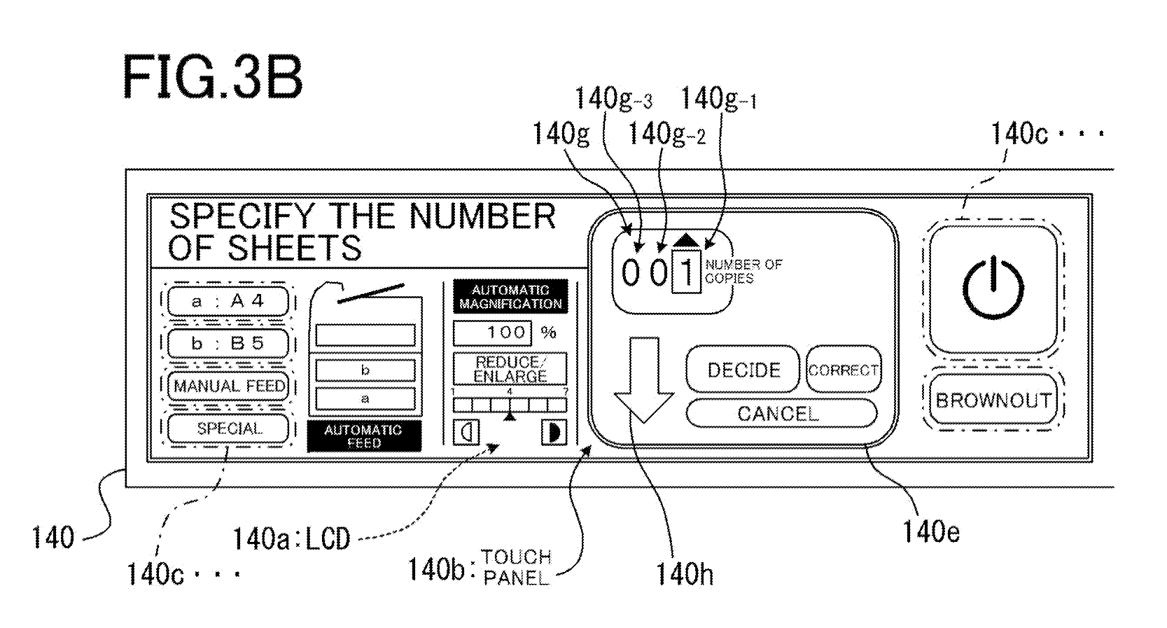

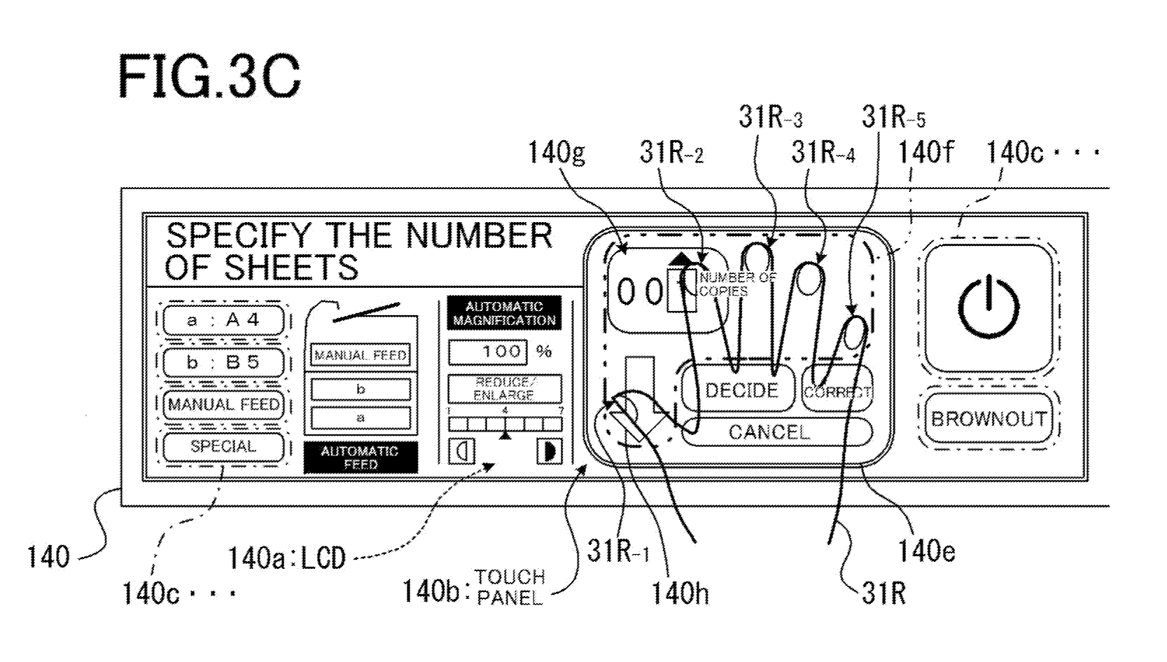

A display example of the LCD 140a that constitutes the operation display part 140 is shown in FIG. 3. Referring to FIG. 3, the LCD 140 provides displays that are shaped similar to buttons for various settings and instruction operations. In addition, on an upper surface of the LCD 140a, there is provided a light-transmitting touch panel 140b that has operation regions 140c, 140c - - - and more, the operation regions 140c, 140c - - - and more being in positional correspondence with the button shaped displays. These displays on the LCD 140a and the operation regions 140c, 140c - - - and more constitute a software key board.

Depressing the software key board by a finger or the like will allow for instructions or operations.

It is to be noted that it is possible to use the touch panel 140b in which these operation regions 140c, 140c - - - , and more are configured, depending on its raw material and operation principle, to be undergo a pushing down with a specified force. Otherwise, it is possible to employ a touch panel that is activated immediately when the operating regions 140c, 140c - - - and more are being in contact with something. Regarding this, throughout the description of the exemplary embodiment of the present invention, the word “depress” will read these actions that include push-down and contact.

FIG. 3A shows a condition of the operation display part 140 when the MFP 11 is inactive in all of copy, facsimile (FAX), scanning, printing, and the like, or when the MFP 11 is in a waiting condition. The MFP 11 indicates buttons 140d-1, 140d-2, 140d-3, 140d-4 and more for selecting operations of “Copy”, “FAX”, “Printer” and more, respectively, at a right side on the LCD 140a.

In addition, the touch panel 140b is provided with an operation region 140d in position so as to correspond to these buttons 140d-1, 140d-2, 140d-3, 140d-4 and more.

In a case where the MFP 11 is being in the waiting condition as shown in FIG. 3A, if the user 30 depresses, for example, the position of the button 140d-1, the MFP 11 begins to operate to function as copier.

It is to be noted that when the user 30 depresses the operation regions 140c, 140c - - - , and more, using, for example, his/her finger or a touch pen, the touch panel 140b issues a signal or a data piece. Then the CPU 110 that receives this signal or the data piece causes the whole MFP 11 to switch from the waiting condition to a copying condition for achieving a copying function. In the description of the exemplary embodiment, describing the preceding switching operation is omitted.

When the MFP 11 is selected to operate as a copier, the button 140d-2 indicating “FAX” function, the button 140d-3 indicating “Scan” function, and the button 140d-4 indicating “Printer” function, which are shown in FIG. 3A, are unnecessary.

Thus, as shown in FIG. 3B, the LCD 140a indicates a numeric input frame 140e at an area that was occupied by the buttons 140d-1, 140d-2, 140d-3, 140d-4, and more.

Further, within the numeric input frame 140e, a numeric display part 140g and an arrow-shaped display symbol 140h are displayed.

In the exemplary embodiment of the present disclosure, the numeric display part 140g is configured to display three decimal digits and a character as unit symbol. Among three digits on the numeric display part 140g, the first digit 140g-1 from the left is indicative of ones. The second digit 140g-2 and the third digit 140g-3 are indicative of tens and hundreds, respectively.

It is to be noted that within the numeric input frame 140e, other than the numeric display part 140g and the display symbol 140h, buttons are displayed that include “Decide”, “Correct”, and “Cancel”. However, these are components of the software key board. Describing these buttons is omitted in association with the description of the exemplary embodiment of the present disclosure.

When the copy function is active, on the touch panel 140b, there is so provided an operation region 140f as to be in positional correspondence to the numeric input frame 140e. The user 30 is allowed to operate with his/her fingers 31R-1 to 31R-5 within the preceding operation region 140f.

It is to be noted that the finger 31R-1, the finger 31R-2, the finger 31R-3, the finger 31R-4, and the finger 31R-5 are indicative of the first finger (thumb) of the right hand, the second finger (index finger or forefinger) of the right hand, the third finger (middle finger or long finger) of the right hand, the fourth finger (ring finger) of the right hand, and the fifth finger (little finger) of the right hand respectively.

In the exemplary embodiment of the present disclosure, the user 30 causes to operate the finger 31R-2 at a position within the operation region 140f. It is expected that the preceding operation will increase or decrease the numeral that is displayed on the numeral display part 140g. In addition, using the finger 31R-1 and the fingers 31R-3 to 31R-5 will help the preceding increasing or decreasing operation. The details thereof will be described later.

It is to be noted that the button displays that include “Decide”, “Correct”, and “Cancel” that are shown in FIG. 3C are identical with those shown in FIG. 3B, which allows for omitting the description of the FIG. 3C-shown button displays.

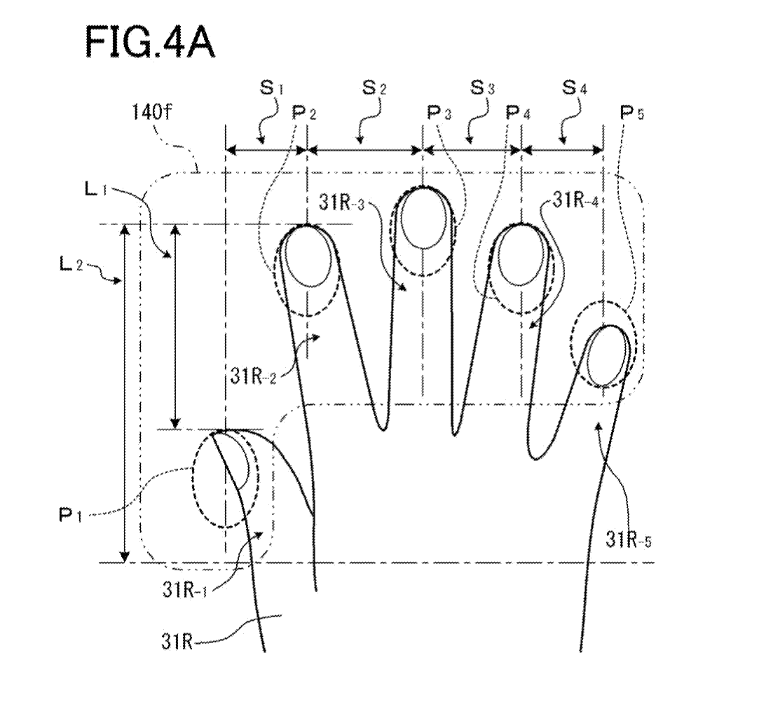

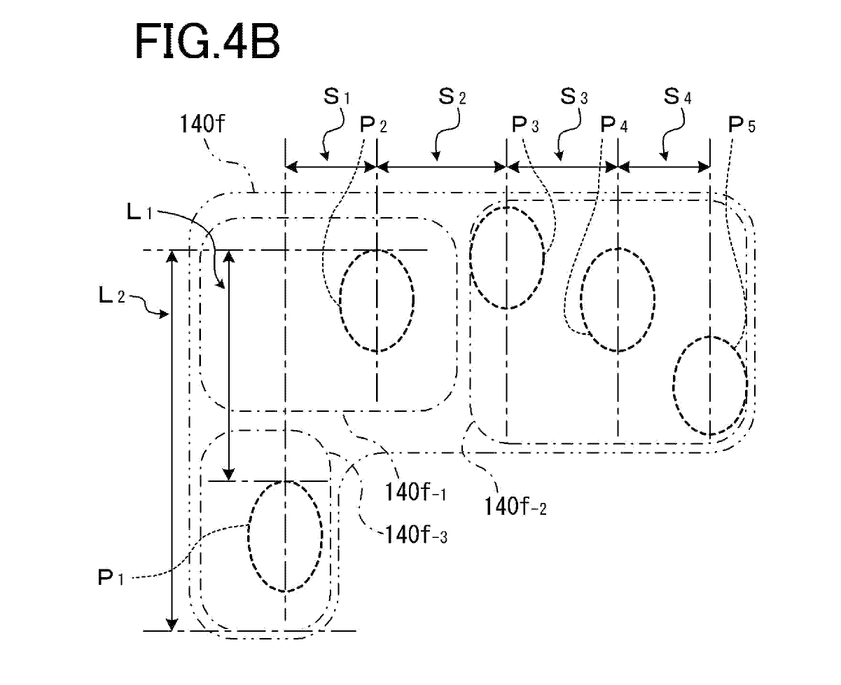

With reference to FIG. 4, an explanation will be made as to how the hand 31R is recognized when the user 30 operates the above-described operation region 140f.

In the case of operating the operation region 140f, the shape of the hand 31R of the user 30 is roughly similar to that shown in FIG. 4A. On that occasion, out of the fingers 31R-1 to 31R-5, the distances between two adjacent fingers are defined as S1, S2, S3, and S4, respectively. In addition, a distance between a distal end of the finger 31R-2 used for increasing or decreasing a numerical value and a distal end of the finger 31R-1 is defined as L1. Further, a distance between the distal end of the finger 31R-2 and the farthest position to which the operation display part 140 is supposed to be opposed is defined as L2.

In the exemplary embodiment of the present disclosure, plural points to be depressed by the fingers 31R-1 to 31R-5 within the operation display region 140f are monitored. The plural points are defined as depression points P-1 to P-5, respectively. These depression points P-1 to P-5 are not fixed points. In brief, the relationship between the positions may vary depending on how large the hand 31R of the user 30 is and/or how the hand 31R is operated.

Then, for example, in a case where a depression is detected at the depression point P-3 rather than the depression point P-2 by the finger 31R-2, if the distance S2 therebetween is less than 5 cm, that both of the finger 31R-2 and the finger 31R-3 are determined to be depressed, respectively. In addition, if the depression point P-4 is determined to be depressed and if the distance S3 between the depression point P-3 and the depression point P-4 is less than 5 cm, all of the fingers 31R-2 to the finger 31R-4 are determined to be depressed, respectively. The same holds true for the depression point P-5.

It is to be noted that in the exemplary embodiment of the present disclosure, it is assumed that the finger 31R-4 will never fail to depress before the finger 31R-3 is depressed. Similarly, it is assumed that the finger 31R-5 will never fail to depress before the finger 31R-4 is depressed.

On the other hand, in a case where a depression is detected at the depression point P-1 rather than the depression point P-2 by the finger 31R-2, if the distance S1 therebetween is less than 5 cm and if the distance L1 is 5 cm or more and the distance L2 is less than 10 cm, both the finger 31R-2 and the finger 31R-1 are determined to be depressed, respectively.

Furthermore, in the exemplary embodiment of the present disclosure, the finger 31R-1 is different from the fingers 31R-3 to 31R-5 in their role, even in the operation assistance the by the finger 31R-2.

Thus, as shown in FIG. 4B, detection regions 140f-1 to 140f-3 are further provided within the operation region 140f. The detection region 140f-1 is for detecting where and how the finger 31R-2 is depressed, while the detection region 140f-2 is for detecting where and how the fingers 31R-3 to 31R-5 is depressed. In addition, the detection region 140f-3 is for detecting where and how the finger 31R-1 is depressed.

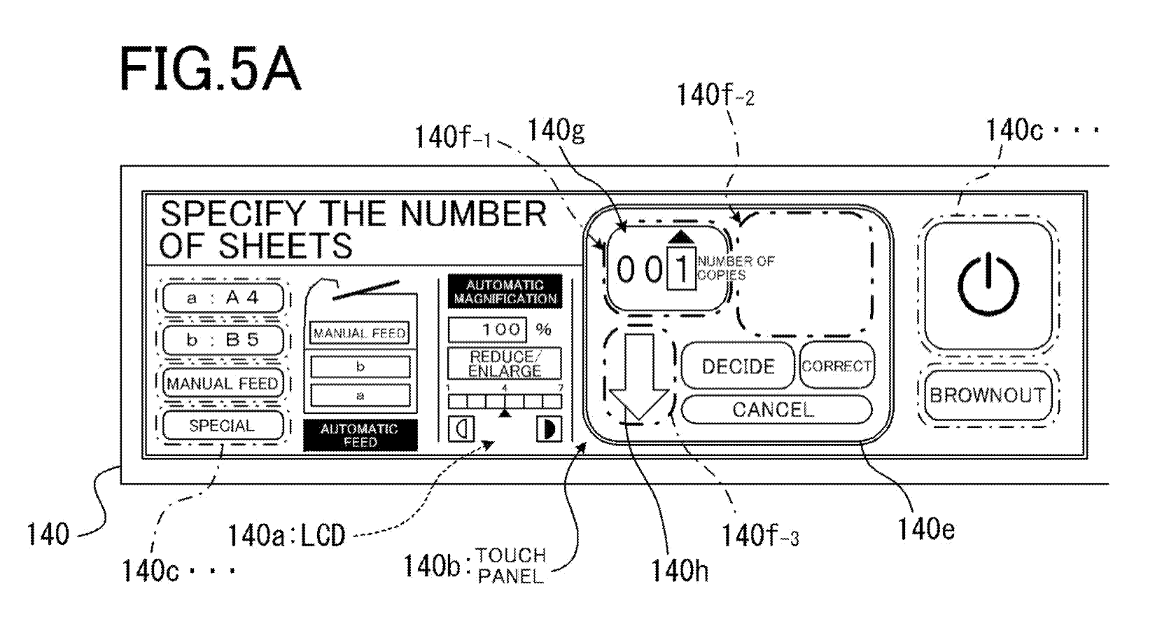

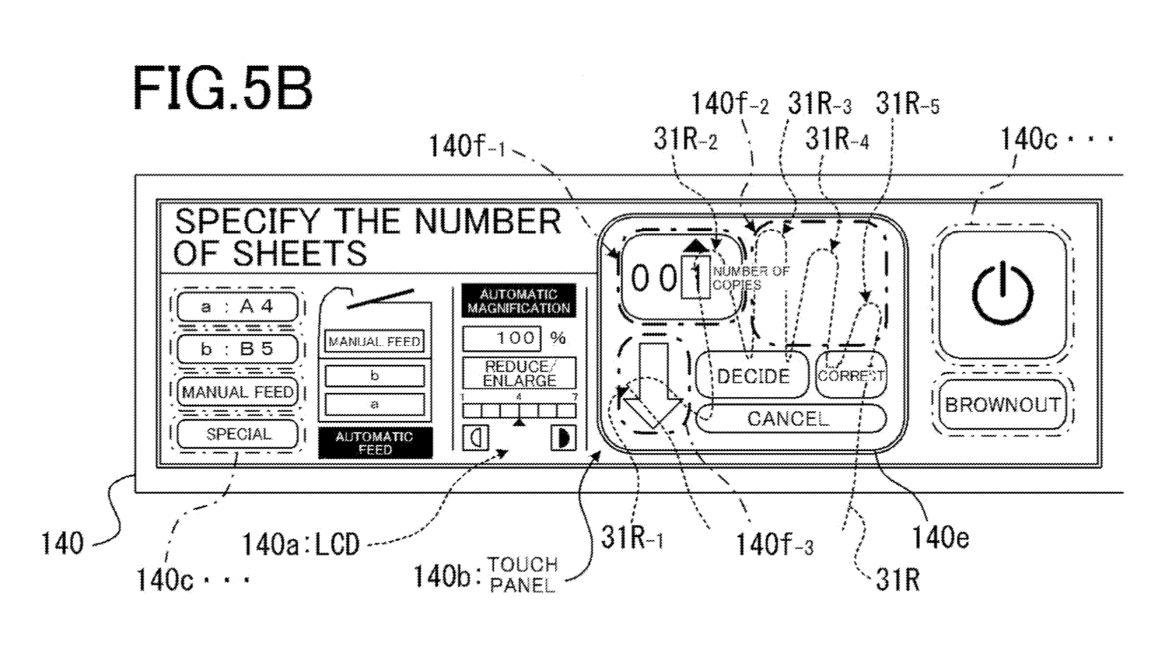

FIG. 5A illustrates a positional relationship between the detection regions 140f-1 to 140f-3 on the operation display region 140. In addition, FIG. 5B illustrates a position of the hand 31R of the user 30 as with that shown in FIG. 5A.

It is to be noted that in these drawings, the frame shown by a dotted-line indicates that the region is provided. Thus, it is not necessary to display the frames shown by the dotted-line on the actual LCD 140a and the touch panel 140b.

Every time the user 30 taps the inside of the detection region 140f-1 with his/her finger 31R-2, the numerical value displayed on the numeric display part 140g changes. For example, the numerical value increases or decreases by 1. In this context, the word “taping” used here is not to depress the touch panel 140b continually but to stop the depression of the touch panel 140b, for example, for a few seconds after the depression is started.

Also, depending on whether the finger 31R-1 depresses the operation display part 140, it is determined to increase or decrease the numerical value of any one of the digits displayed on the numeric display part 140g. Further, depending on how the fingers 31R-3 to 31R-5 are depressed allows the user 30 to perform an operation of increasing or decreasing the numerical value of any one of the digits displayed on the numeric display part 140g.

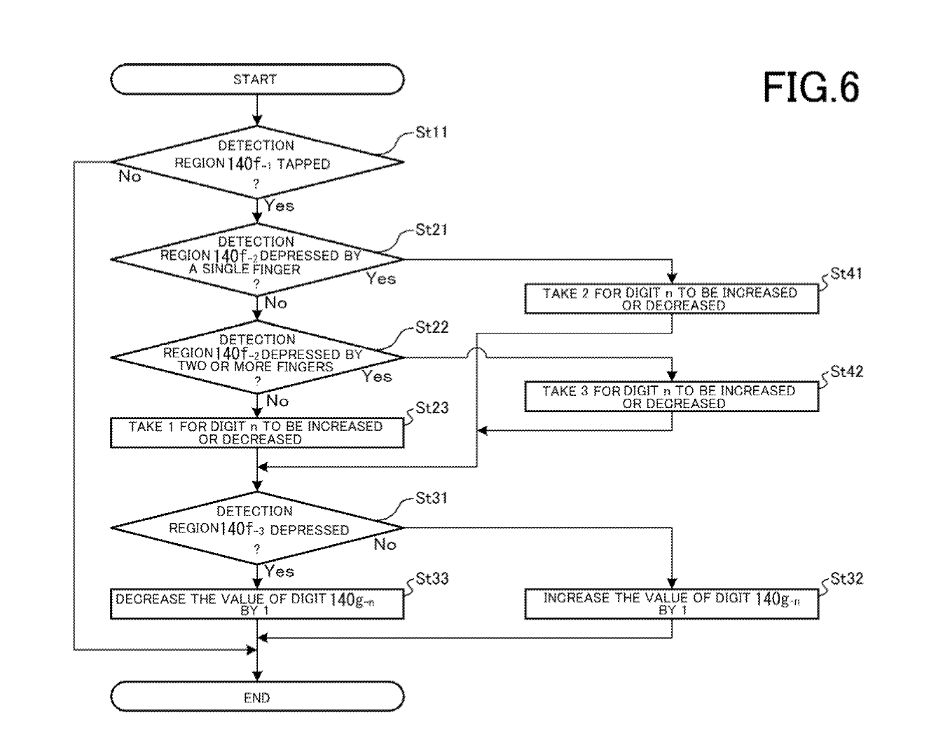

Hereinafter, an explanation is made as to how to change the numerical value on the numeric display part 140g in response to the operation inside the numeric input frame 140e. A flowchart shown in FIG. 6 is indicative of one cycle of a monitoring procedure by the CPU 110 out of repeated monitoring of the depression points P-1 to P-5 inside the operation region 140f.

Referring to FIG. 6, first of all, it is determined whether or not the detection region 140f-1 is tapped (Step St11). If not, one cycle of the monitoring procedure is terminated.

In Step St11, if yes, it is determined whether or not the detection region 140f-2 is depressed by any one of the fingers 31R-3 to 31R-5 (Step St21).

In Step St21, if the detection region 140f-2 is determined not to be depressed by a single finger, then if the detection region 140f-2 is determined to be depressed by two or more of the fingers 31R-3 to 31R-5 (Step St22).

In Step St22, if the detection region 140f-2 is determined not to be depressed by two or more of the fingers 31R-3 to 31R-5 (Step St22), 1 is taken for n used for designating the digit 140g-n (see FIG. 3B) among the numerical value on the numeric display part 140g, which is to be increased or decreased (Step St23).

Thereafter, it is determined whether or not the detection region 140f-3 is depressed (Step St31). If not, 1 is added to the value of the digit 140g-n (Step St32).

If the value of each the digit is 9, it is arbitrary as to how proceed after this whether or not an addition is performed to this digit, whether or not this digit is carried over, and whether or not prohibition is imposed in order for the number of sheets to decrease to 0. Thus, explanations of these processes are omitted.

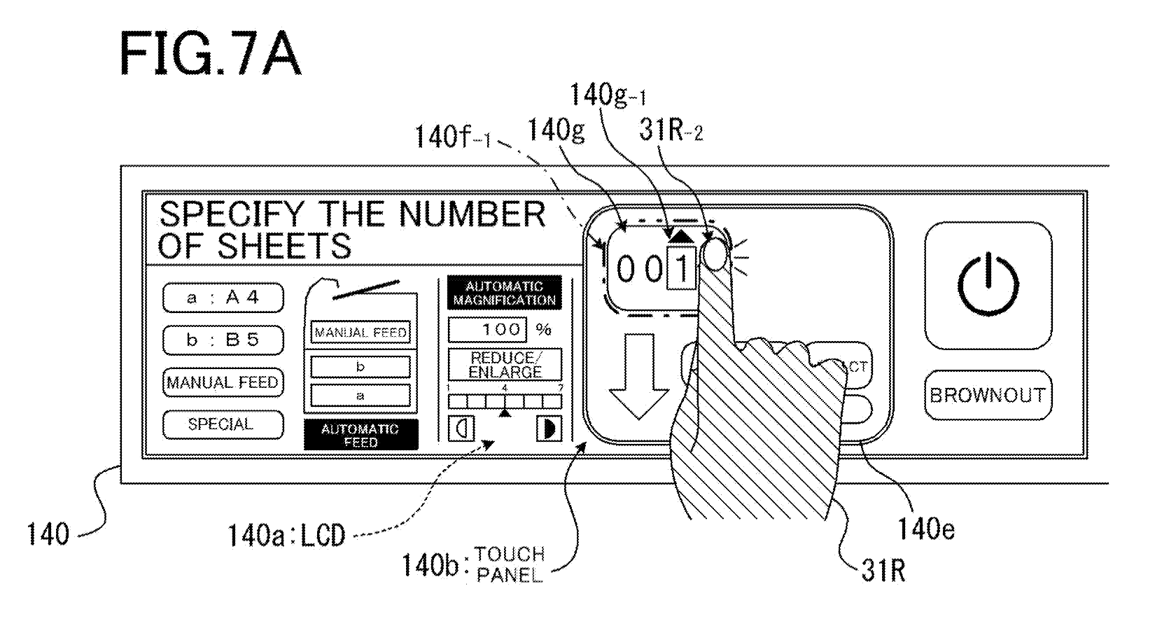

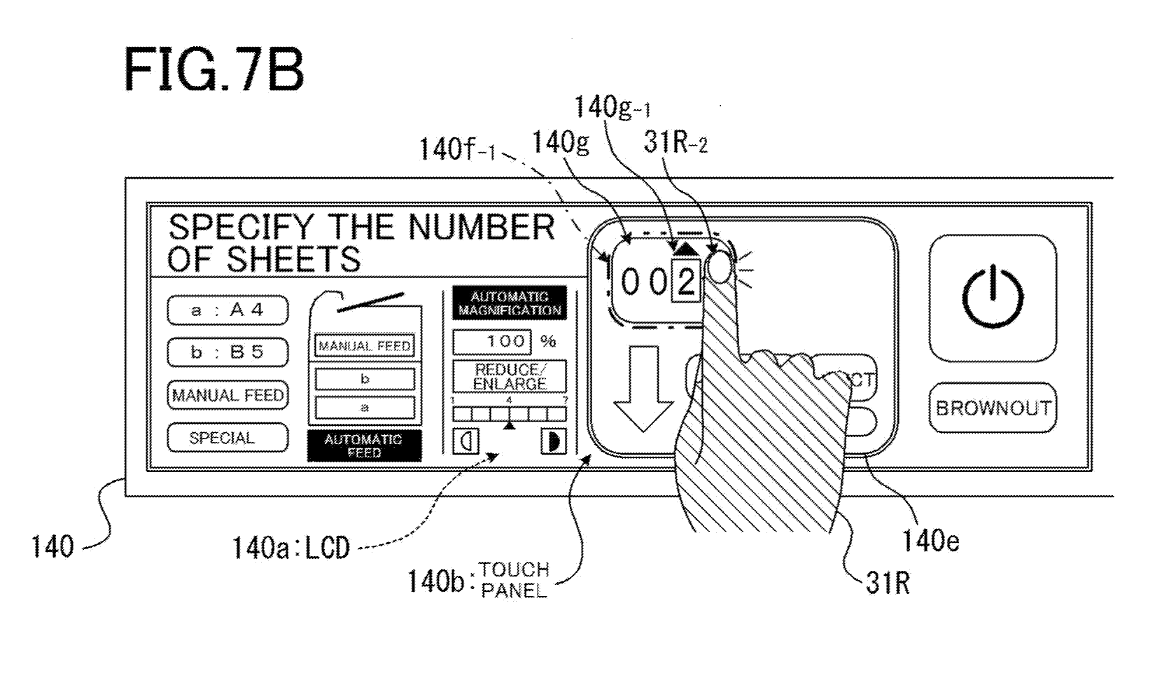

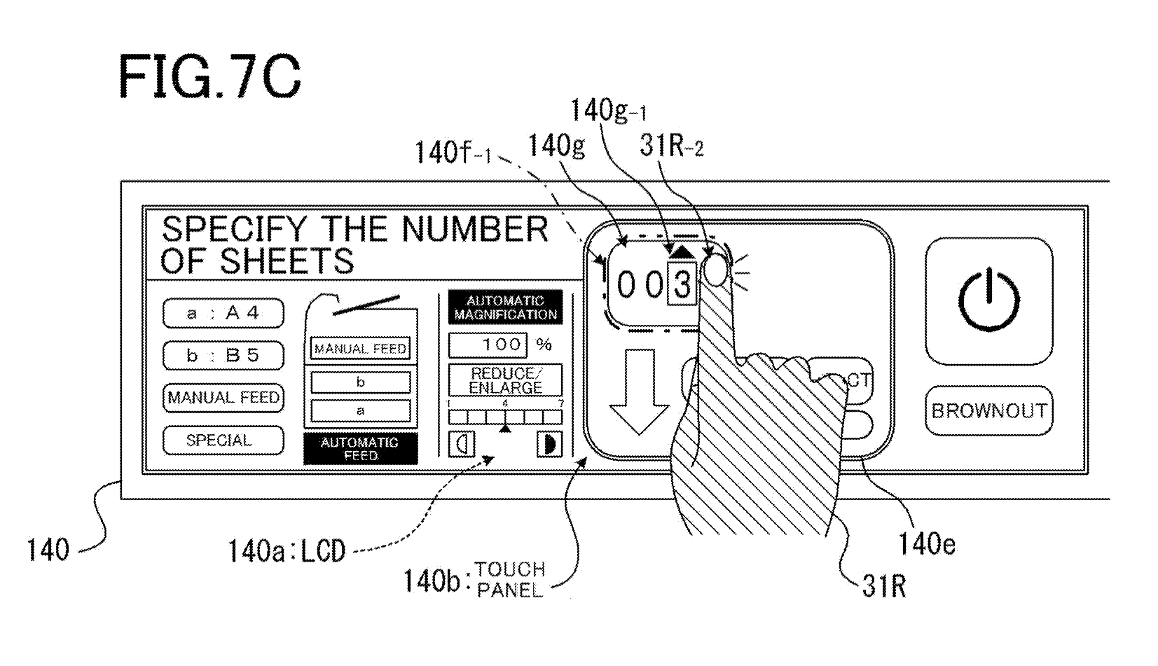

In FIG. 7, there is shown thus obtained condition of the operation display part 140 when the detection region 140f-2 and the detection region 140f-3 are not depressed and concurrently when only the detection region 140f-1 is tapped. Each the drawing in FIG. 7 illustrates that the user 30 taps only the detection region 140f-1 with his/her finger 31R-2 of the hand 31R.

In such a case, as shown in FIG. 7A, a symbol such as a frame is provided to enclose the value of the digit 140g-1 for indicating that this value is to be increased or decreased. Concurrently, another symbol such as solid triangle is displayed that means of an increase of value due to tapping action.

In FIG. 7A, the value of the digit 140g-1 is 1. However, tapping the detection region 140f-1 causes the value of the digit 140g-1 to 2 in FIG. 7B. Similarly, tapping the detection region 140f-1 causes the value of the digit 140g-1 to 3 in FIG. 7C.

On the other hand, the aforementioned Step St21 determines that the detection region 140f-2 is depressed by only one finger, it is given that n=2 (Step St41) for designating the digit 140g-n which is to be increased or decreased among the numerical value on the numeric display part 140g.

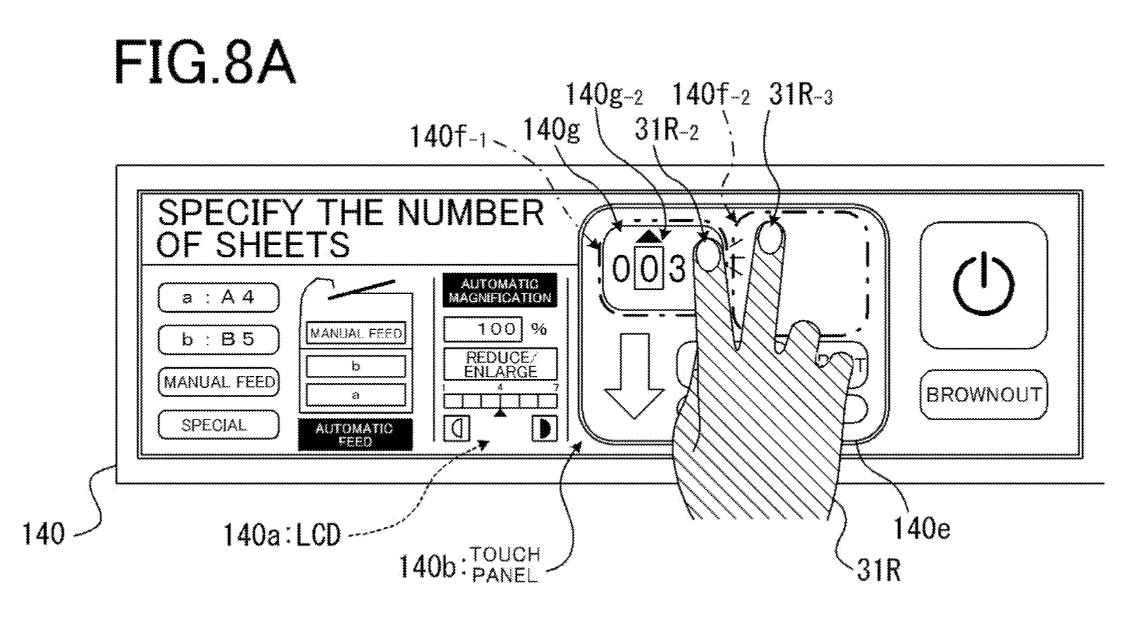

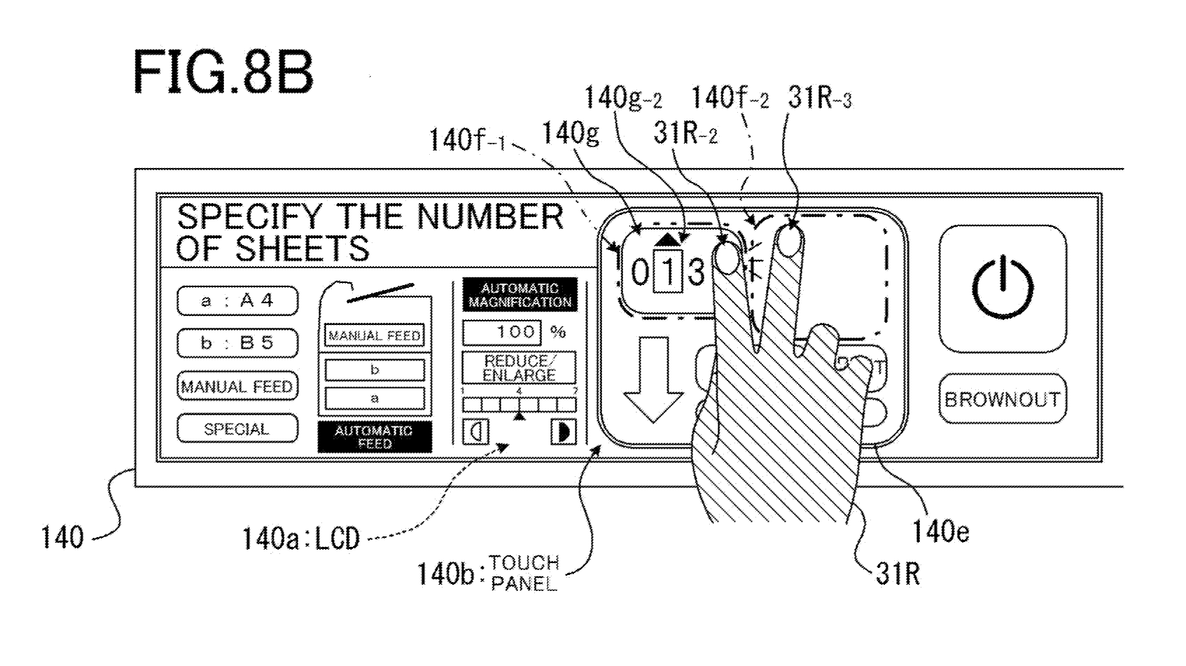

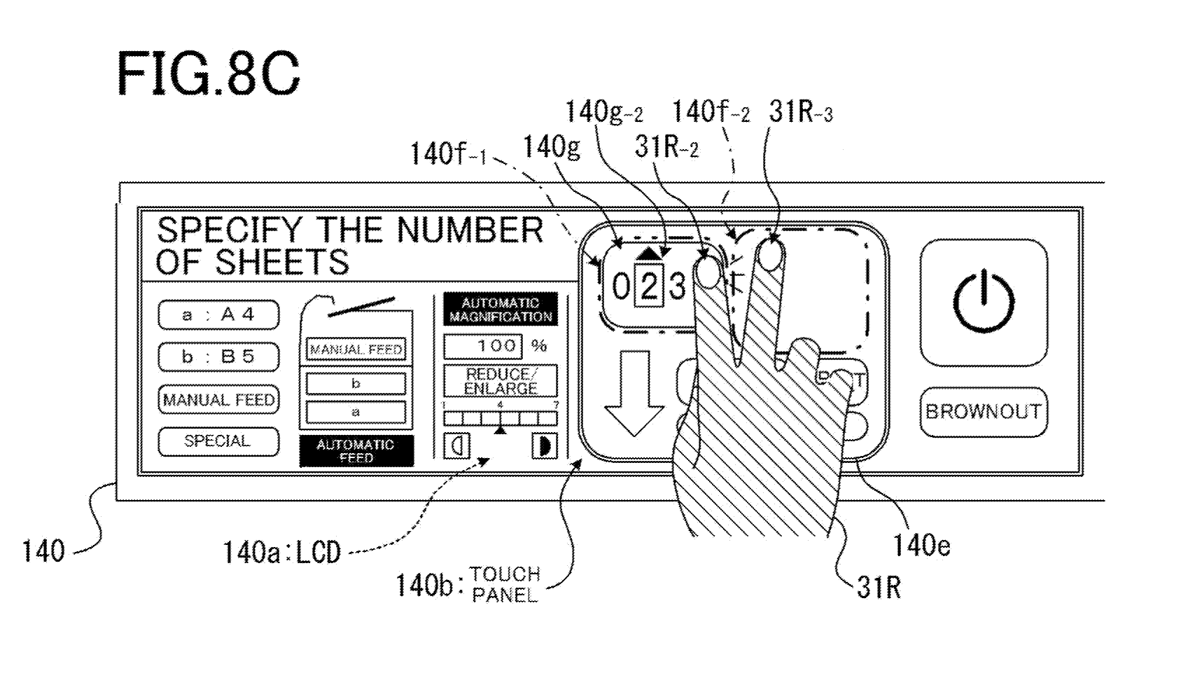

Here, in FIG. 8, there is shown a condition of the operation display part 140 when the detection region 140f-2 are depressed by a single finger and concurrently when the detection region 140f-1 is tapped, while the detection region 140f-3 is not tapped3 are not depressed and concurrently when only the detection region 140f-1 is depressed. In each the drawing in FIG. 8, the user 30 taps the detection region 140f-1 with his/her finger 31R-2 of the hand 31R while the user 30 depresses the detection region 140f-2 with his/her finger 31R-3.

In such a case, as shown in FIG. 8A, a symbol such as a frame is provided to enclose the value of the digit 140g-2 for indicating that this value is to be increased or decreased. Concurrently, another symbol is displayed that means an increase of value due to tapping action.

In FIG. 8A, the value of the digit 140g-2 is 0. However, tapping the detection region 140f-1 causes the value of the digit 140g-2 to be 1 in FIG. 8B. Similarly, tapping the detection region 140f-1 causes the value of the digit 140g-2 to be 3 in FIG. 8C.

Furthermore, the aforementioned Step St22 determines that the detection region 140f-2 is depressed by two or more fingers, it is given that n=3 (Step St42) for designating the digit 140g-n which is to be increased or decreased among the numerical value on the numeric display part 140g. Then, the control goes to Step St31.

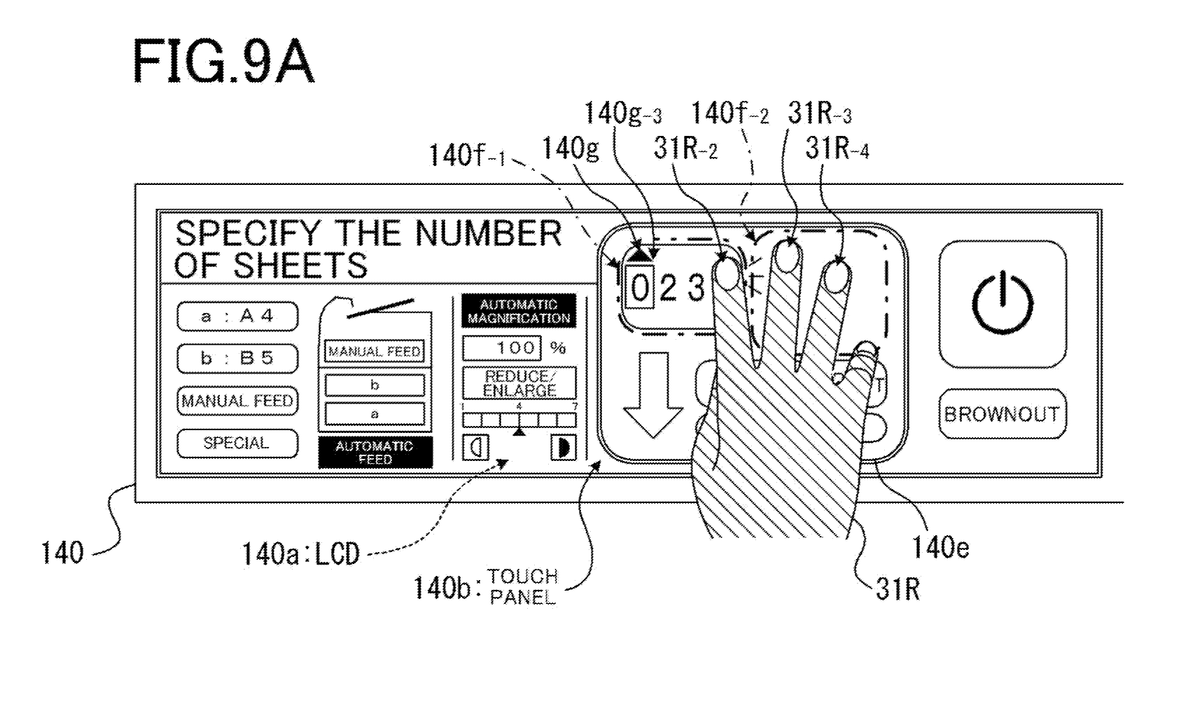

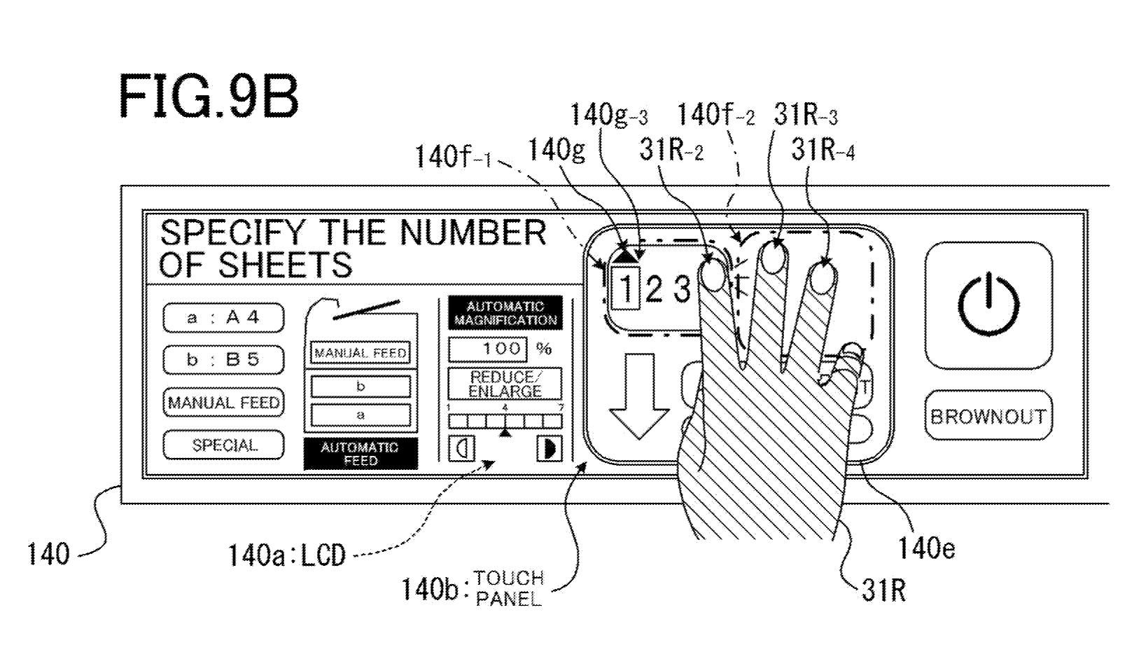

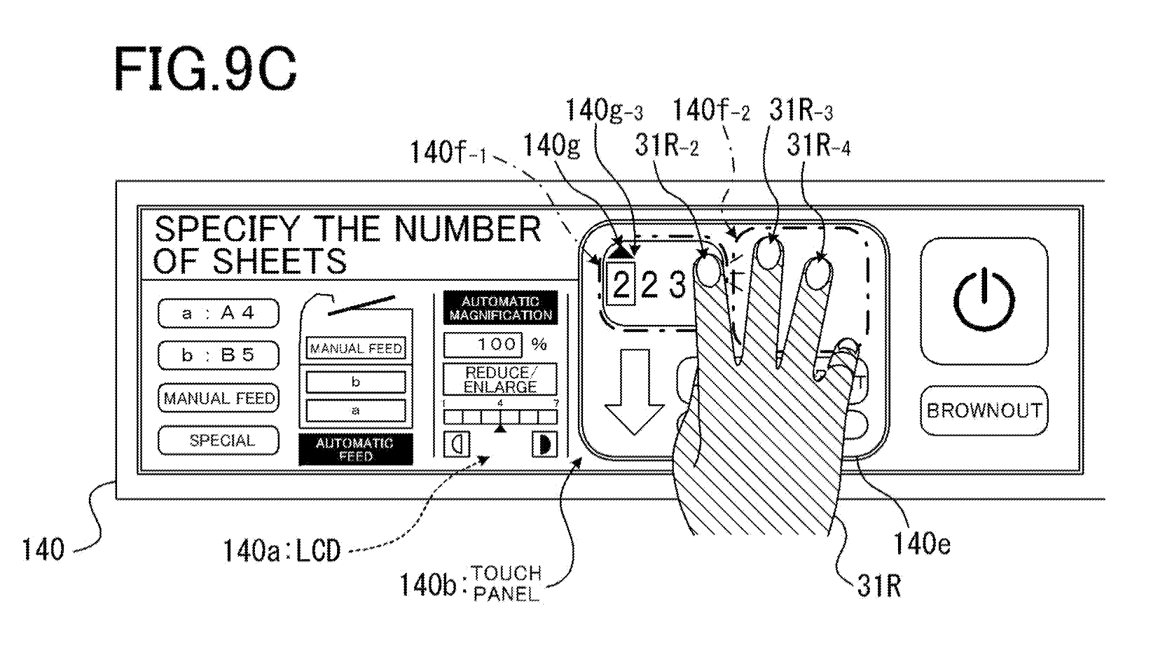

Here, in FIG. 9, there is shown a condition of the operation display part 140 when the detection region 140f-2 is depressed by two fingers and concurrently when the detection region 140f-1 is tapped, while the detection region 140f-3 is depressed. In each the drawing in FIG. 9, the user 30 taps the detection region 140f-1 with his/her finger 31R-2 while the user 30 depresses the detection region 140f-2 with his/her fingers 31R-3 and 31R-4 of the hand 31R.

In such a case, as shown in FIG. 9A, a symbol such as a frame is provided to enclose the value of the digit 140g-3 for indicating that this value is to be increased or decreased. Concurrently, another symbol is displayed that means an increase of value due to tapping action.

In FIG. 9A, the value of the digit 140g-3 is 0. However, tapping the detection region 140f-1 causes the value of the digit 140g-3 to 1 in FIG. 9B. Similarly, tapping the detection region 140f-1 in FIG. 9B causes the value of the digit 140g-3 to 2 in FIG. 9C.

Incidentally, the aforementioned Step St31 determines that the detection region 140f-3 is depressed, the value of the digit 140g-n is decreased by 1 (Step St33).

In a case where the value of each the digit 140g-n in Step St33 is 0, it is arbitrary as to how proceed after determining whether or a subtraction is made on this digit, whether or not a carry down is made in this digit, and whether or not an inhabitation is established for specifying the number of sheets to 0 or less. Thus, explanations on these processes are omitted.

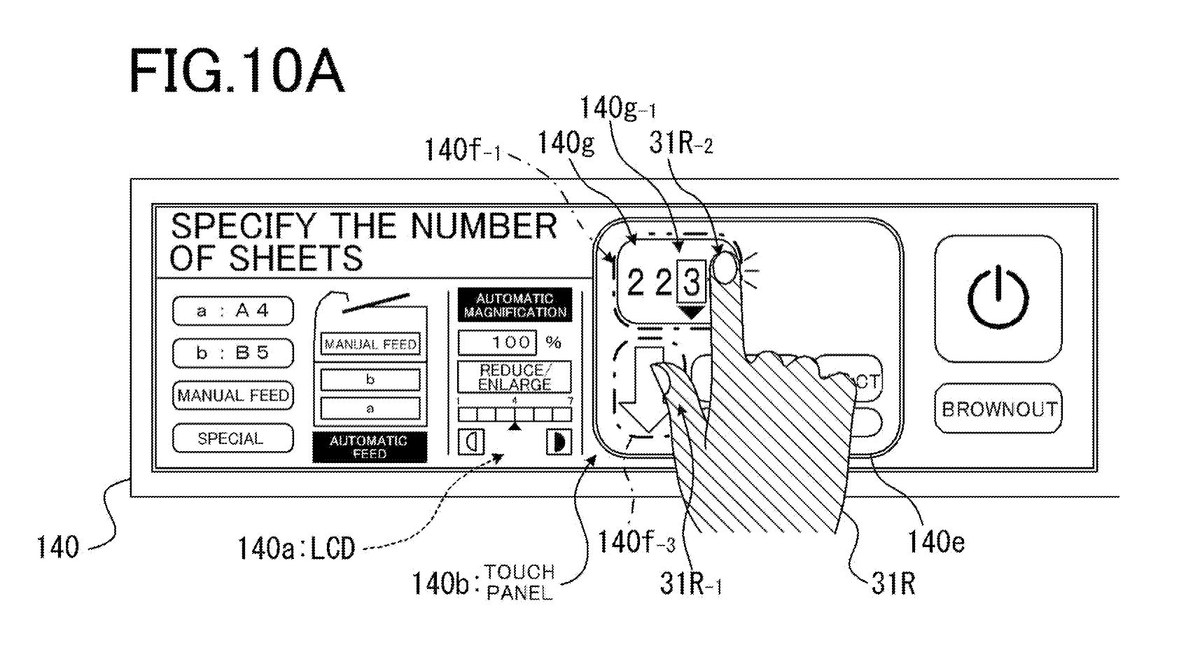

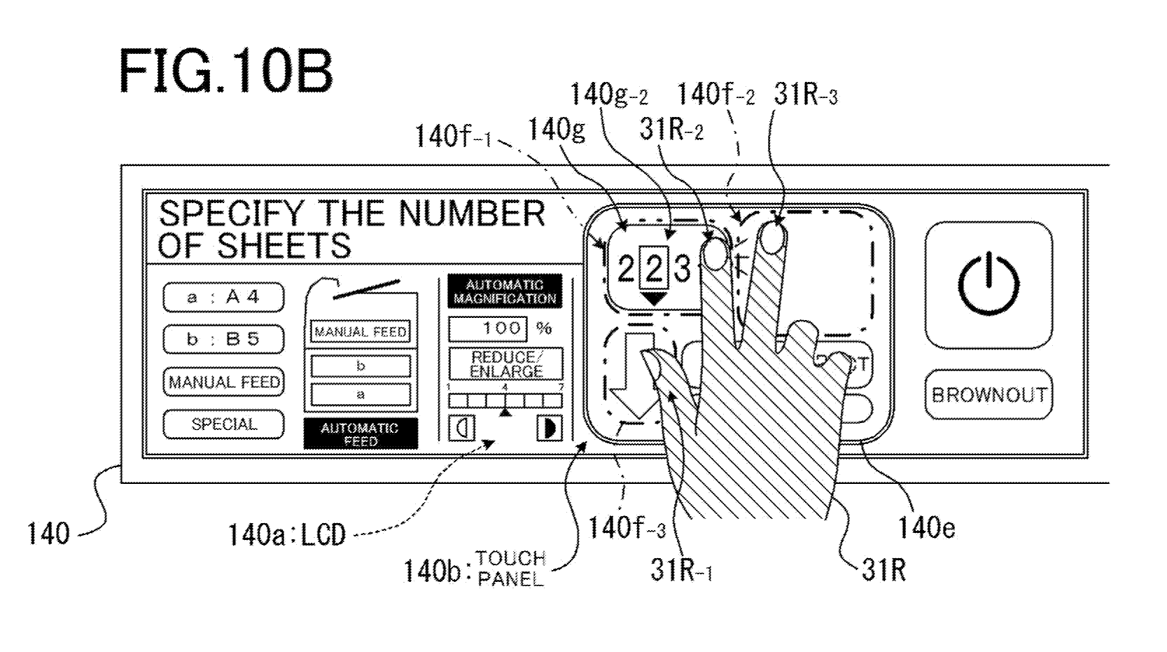

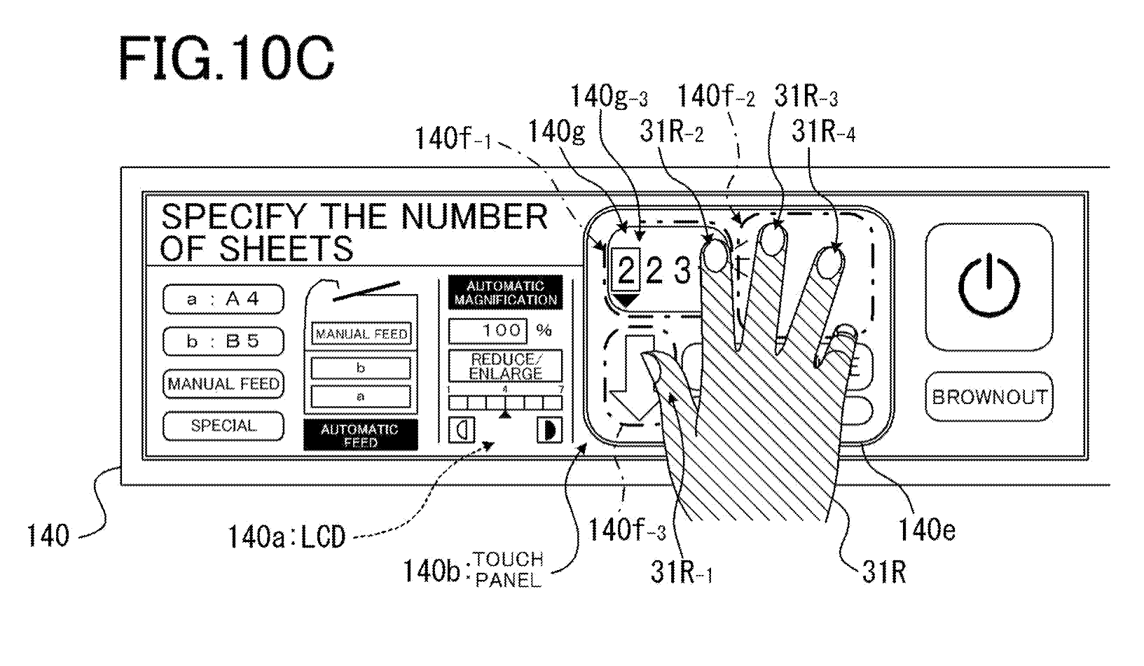

Here, in FIG. 10, there is shown a condition of the operation display part 140 when the detection region 140f-3 is depressed and concurrently when the detection region 140f-1 is tapped.

In FIG. 10A, the user 30 (not shown) taps the detection region 140f-1 with his/her finger 31R-2 of the hand 31R while depressing the detection region 140f-3 with his/her finger 31R-1 of the hand 31R.

In such a case, a symbol such as an inverted solid triangle is provided at a peripheral such as lower side of the value of the digit 140g-1 for indicating that this value is to be increased or decreased.

That is to say, under the condition shown in FIG. 10A, while the detection region 140f-3 is being depressed, every time the detection region 140f-1 being tapped, the value of the digit 140g-1 is decreased by 1.

On the other hand, in FIG. 10B, the user 30 takes concurrent actions that include depressing the detection region 140f-3 with his/her finger 31R-1 of the hand 31R, depressing the detection region 140f-2 with his/her finger 31R-3, and tapping the detection region 140f-1 with his/her finger 31R-2.

In such a case, a symbol such as a frame is provided at a peripheral of the value of the digit 140g-2 for indicating that this value is to be increased or decreased. Concurrently, another symbol is displayed that means of a decrease of value due to tapping action.

That is to say, under the condition shown in FIG. 10B, while the detection region 140f-3 is being depressed, every time the detection region 140f-1 being tapped, the value of the digit 140g-2 is decreased by 1.

Furthermore, in FIG. 10C, the user 30 takes concurrent actions that include depressing the detection region 140f-3 with his/her finger 31R-1 of the hand 31R, depressing the detection region 140f-2 with his/her fingers 31R-3 and 31R-4, and tapping the detection region 140f-1 with his/her finger 31R-2.

In such a case, a symbol such as a frame is provided at a peripheral of the value of the digit 140g-3 for indicating that this value is to be increased or decreased. Concurrently, another symbol is displayed that means of a decrease of value due to tapping action.

That is to say, under the condition shown in FIG. 10C, while the detection region 140f-3 is being depressed, every time the detection region 140f-1 being tapped, the value of the digit 140g-3 is decreased by 1.

As described above, the exemplary embodiment of the present disclosure makes it possible to achieve a numeric input operation such as an input of the number of sheets to be copied by merely tapping the touch panel and/or making a finger depression on the touch panel. Thus, it is possible to establish a quick and simple numeral inputting. This inputting is carried out without having to have a hardware ten key pad and also without having to switch an operation display part to a ten key display.

In such a case, a mere doing a simple operation at and/or around the portion of the numeric display that is visible through the touch panel will cause the numerical value to increase or decrease. That is to say, the operation can be achieved while viewing how the numeric is increased or decreased, which causes an input operation to be easy and prevents an erroneous input.

It is to be noted that the present disclosure is not limited to the above-described exemplary embodiment and therefore obviously various modification maybe made within the scope of the spirit of the present disclosure.

For example, in a case where a visual location of the detection position 140f-2 is difficult that is to be depressed when designating a digit for increasing or decreasing numerical value (see, for example FIG. 3B), the LCD 140a may be provided with a symbol as a visual guidance display that is to be depressed by the fingers 31R-3, 31R-4, - - - .

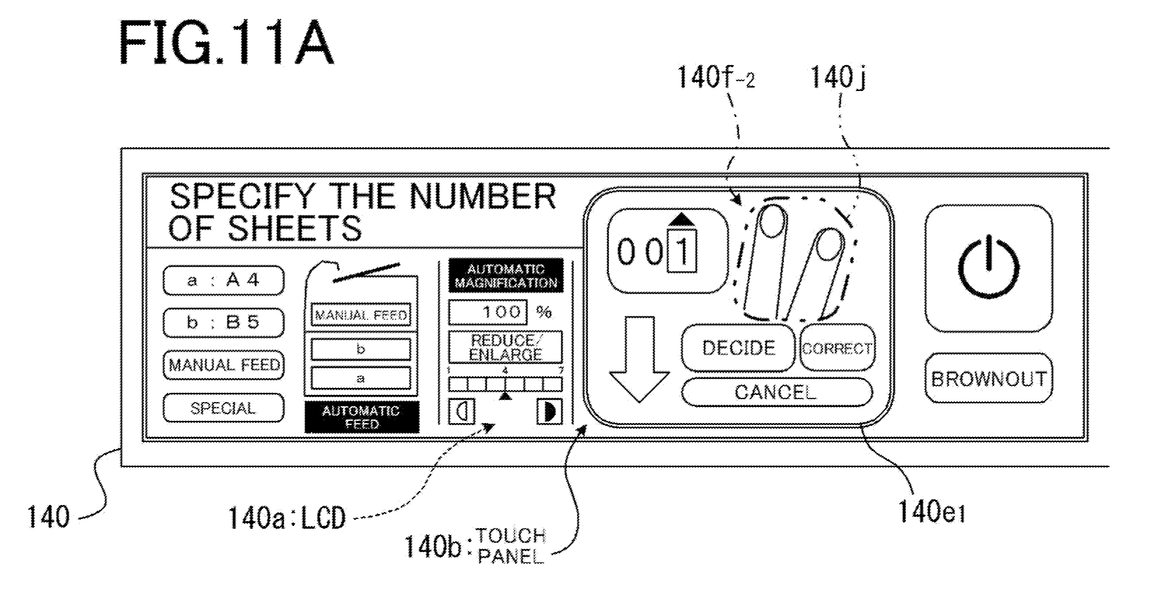

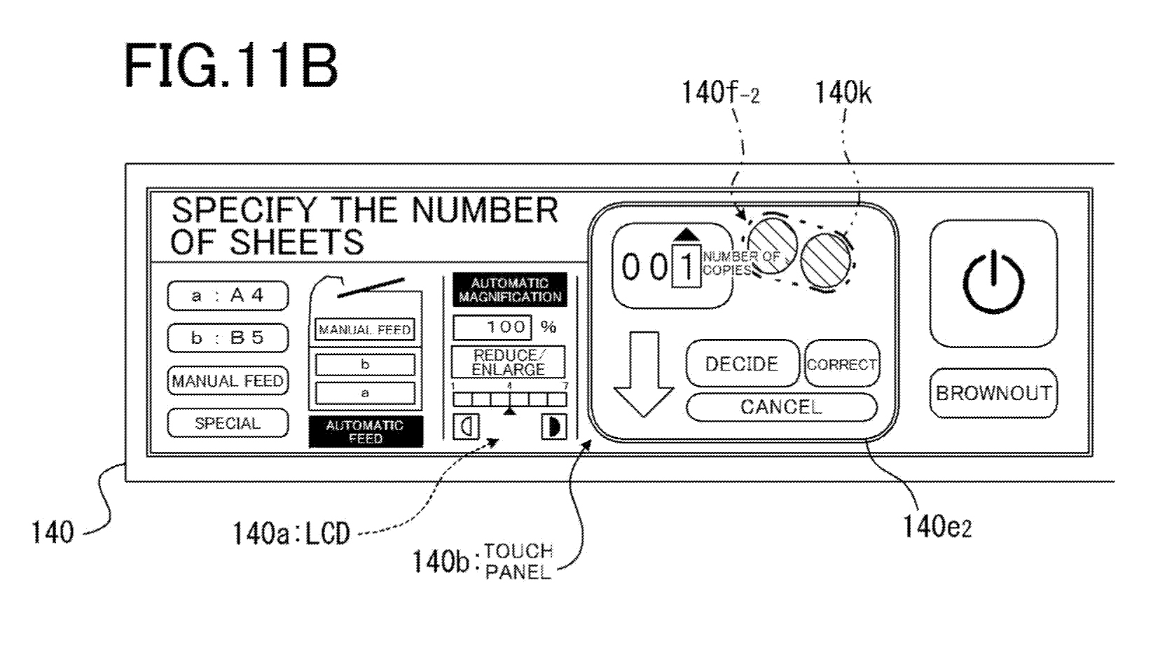

In detail, in FIG. 11A, there is provided a symbol 140j that is indicative of the fingers 31R-3, 31R-4, - - - within the numerical input frame 140e1 on the LCD 140a. In addition, in FIG. 11B, there is provided a symbol 140k within the numerical input frame 140e2 on the LCD 140a, the symbol 140k including a circle, an oval etc. as guidance displays for depressions by the fingers 31R-3, 31R-4, - - - .

In the above-described exemplary embodiment, while the detection region 140f-3 is being depressed, every time the detection region 140f-1 is tapped, the numerical value of either one the digits 140g-1 to 140g-3 is decreased by 1. As to this, it may be modified to that every time the detection region 140f-1 is tapped, the numerical value of either one the digits 140g-1 to 140g-3 is alternately decreased by 1 and increased by 1.

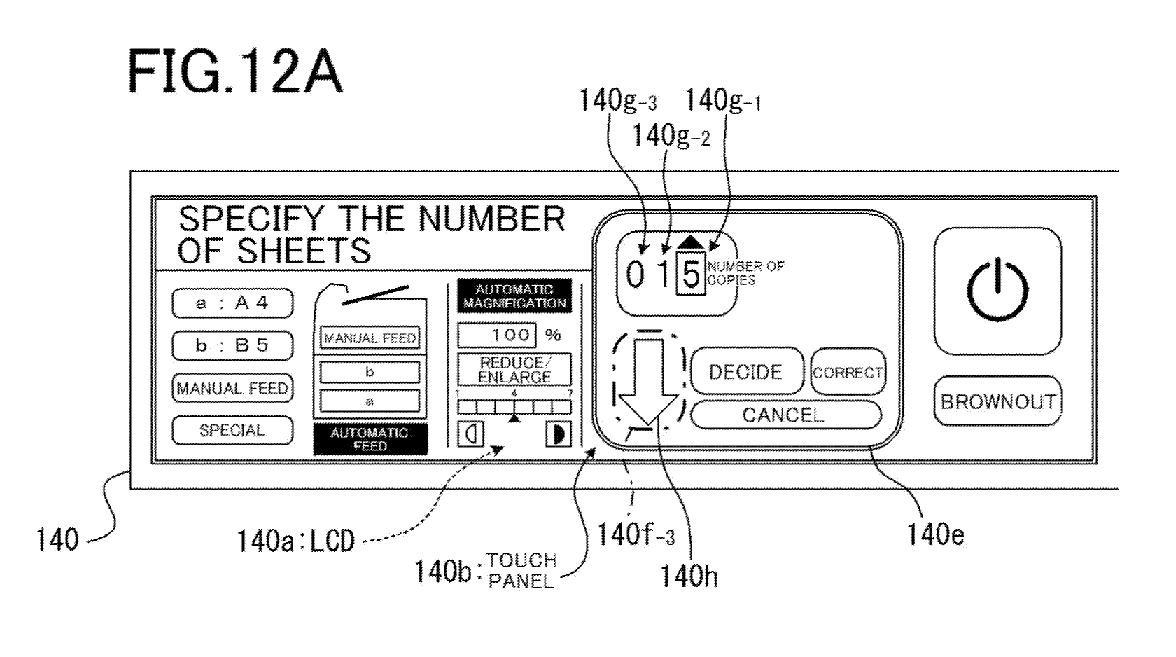

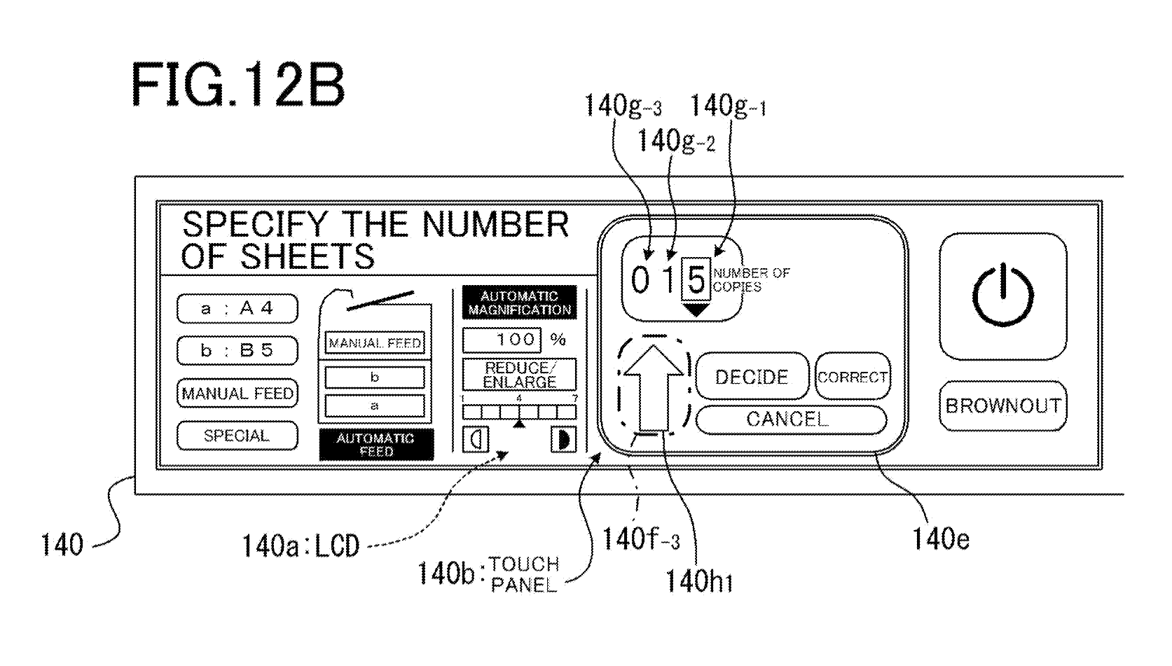

FIG. 12 illustrates a detailed condition of the operation display part 140. For example, in FIG. 12A, there is shown a display mark 140h having a down arrow shape in the numeric input frame 140e. Concurrently, at an upper side of the numeric value on the digit 140g-1, there is shown a solid triangle that is indicative of an increase of value every time a tapping action is made. Under this condition, tapping the detection region 140f-1 causes the value on the digit 140g-1 (either one of the digits 140g-1 to 140g-3) to increase by 1.

Then, tapping the detection region 140f-3 causes the display mark having an up arrow shape to appear in the numeric input frame 140e as shown in FIG. 12B. Concurrently, at a lower side of the numerical value on the digit 140g-1, a symbol having a shape of inverted solid triangle appears which is indicative of a decrease of the value by the tapping action. Under the resulting condition, one tapping action on the detection region 140f-1 causes the numerical value on the digit 140g-1 to decrease by 1. This can be applied to either one of the digits 140g-1 to 140g-3.

Under the condition shown in FIG. 12B, tapping the detection region 140f-3 cases the condition shown in FIG. 12A appears again. That is to say, every time a tapping action is applied to the detection region 140f-3 a transition between the condition shown in FIG. 12A and the condition FIG. 12B is repeated.

In such a case, it is possible to configure such that every time a long press is applied to the detection region 140f-3 a transition between the condition shown in FIG. 12A and the condition FIG. 12B is repeated. Here, the long press is a continual depression on the touch panel 140b for a time duration of, for example, 1 second or above.

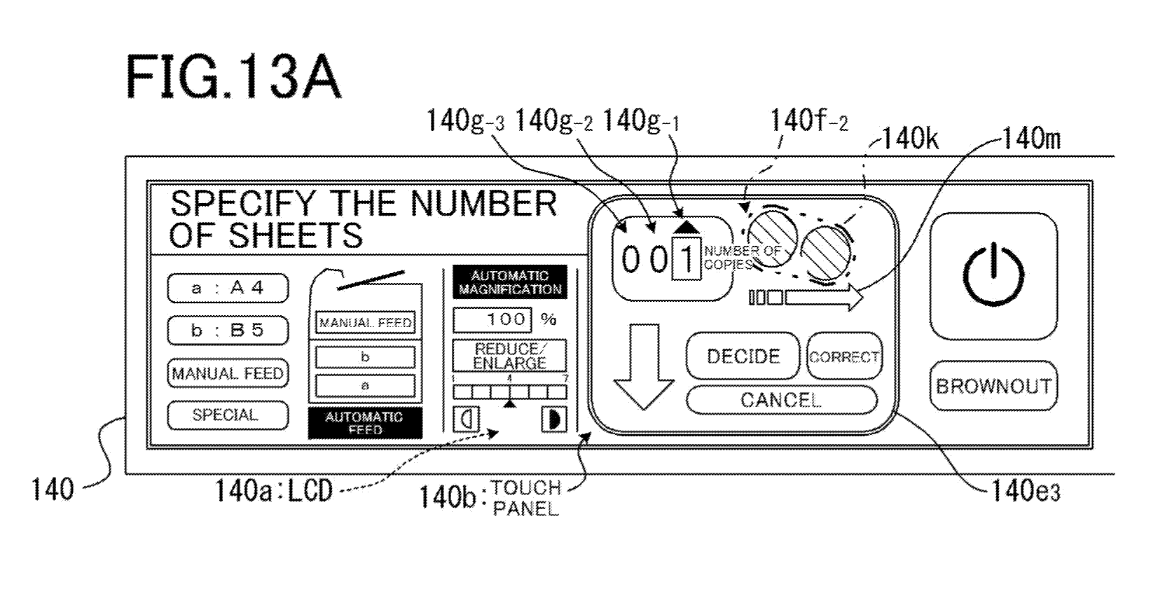

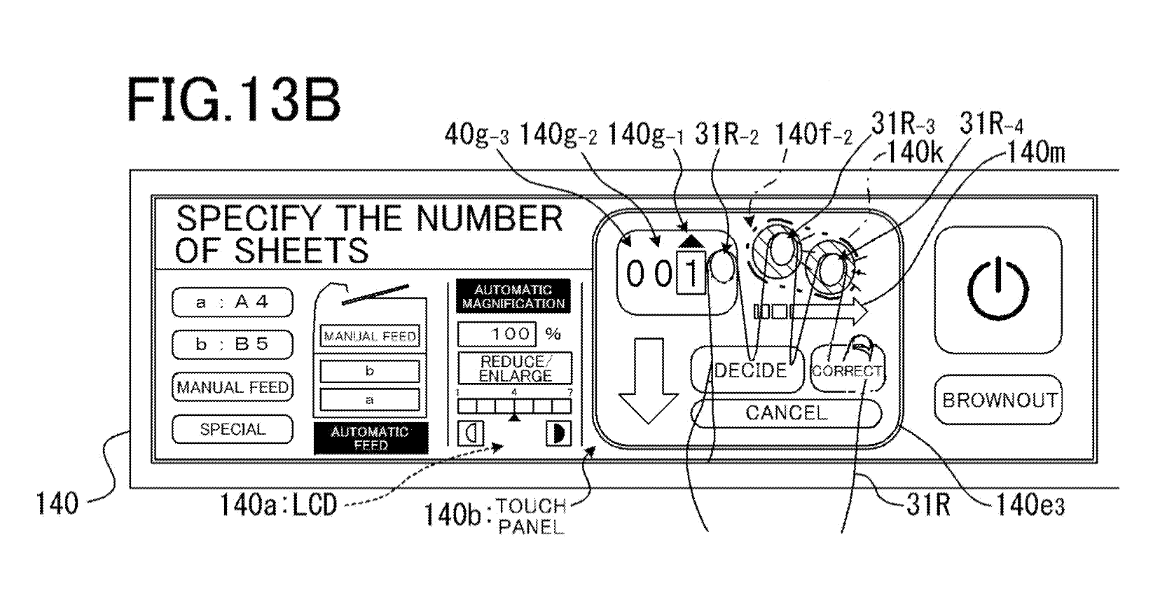

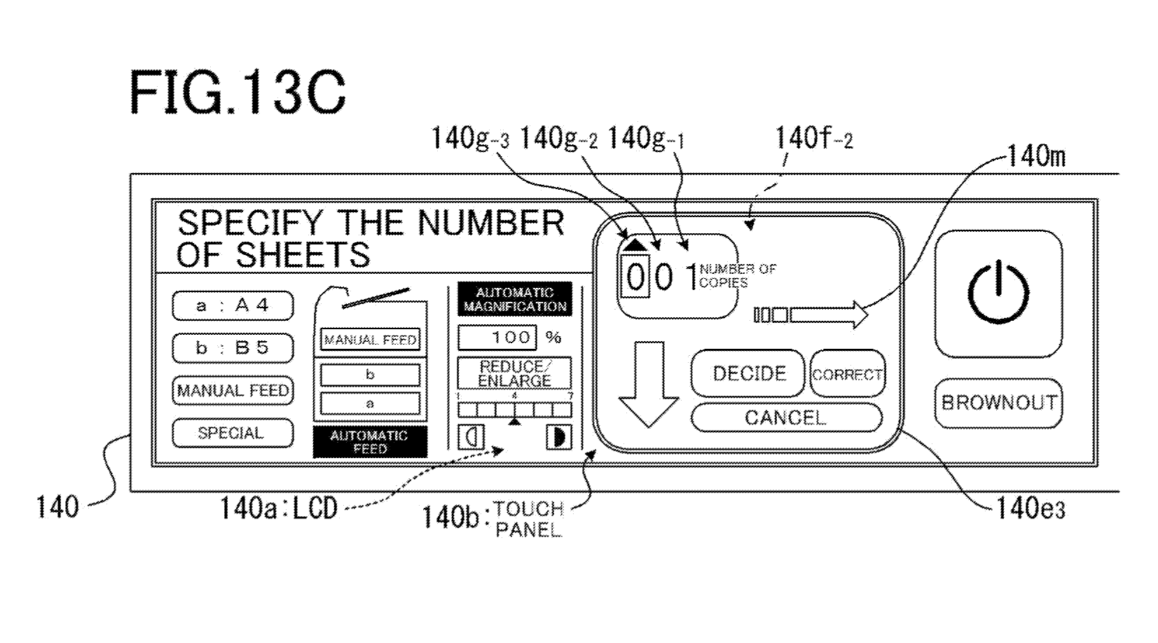

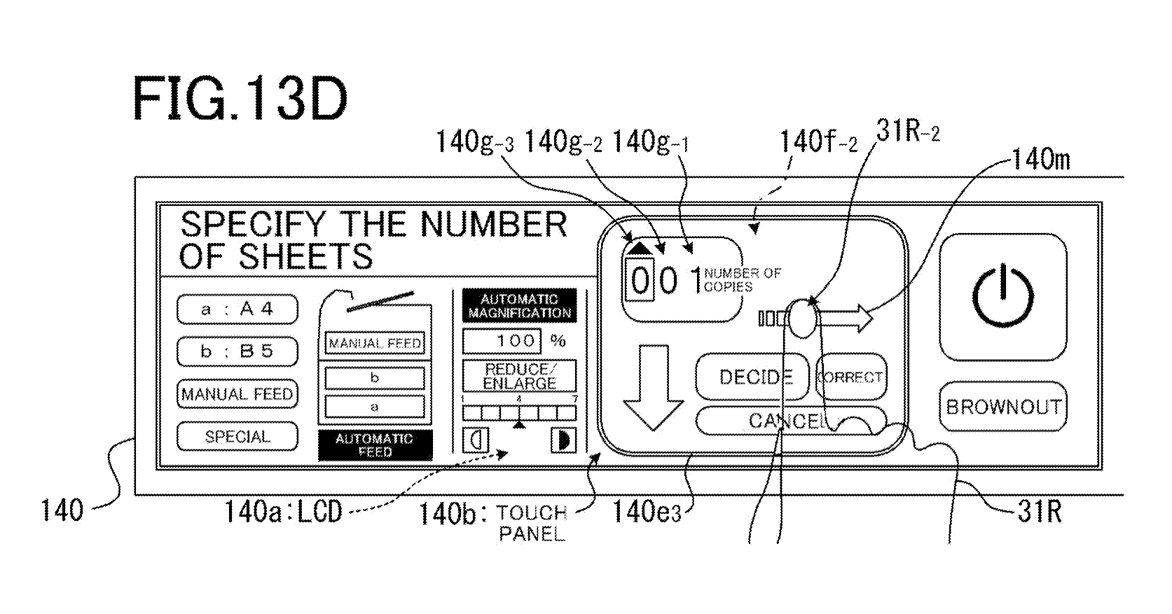

Further, a tapping action or long press on the detection region 140f-2 may designate either one of the digits 140g-1 to 140g-3 which is to be increased or decreased. For example, in FIG. 13A, there is displayed a symbol (circle or oval) 140k within the numeric input frame 140e3 (on the LCD 140a) which acts as a depression guidance for the fingers 31R-3, 31R-4 - - - . At a portion corresponding to the detection region 140f-2, a display mark 140m is displayed that has a shape of horizontal arrow (right arrow), in addition to the symbol 140m.

Here, in FIG. 13B, the fingers 31R-3 and 31R-4 tap the position with the symbol 140k (i.e., the detection region 140f-2 is tapped by two fingers). Thereby, the target is switched to the digit 140g-3 whose numerical value is to be increased or decreased in the numeric display part 140g. Simultaneously, as shown in FIG. 13C, around the numerical value of the digit 140g-3, there are displayed symbols including frames and marks that are indicative of the subjects to be increased or decrease.

It is to be noted that such a case allows a tapping action on the detection region 140f-2 not to shift the digit 140g-n and therefore the symbol 140k within the numeric input frame 140e-3 has been deleted.

For returning the numerical value of the digit 140g-1 (or the digit 140g-2) to an object to be increased or decrease, it is necessary for any one of the fingers 31R-1 to 31R-5 to depress the display symbol 14m on the touch panel 140b and thereafter to slide the resulting finger in the arrow direction that is indicated by the display mark 140m.

For example, in FIG. 13D, the finger 31R-2 that depresses the portion indicated by the display symbol 140m is brought into the sliding movement. Thereby, the numerical value of the digit 140g-1 is returned to the object to be increased or decreased, and the condition shown in FIG. 13A appears.

The above-described examples presume that the user 30 takes actions with his/her right hand 31R. However, the present disclosure does not limit to a right-hand operation and therefore allows the left-hand to operation.

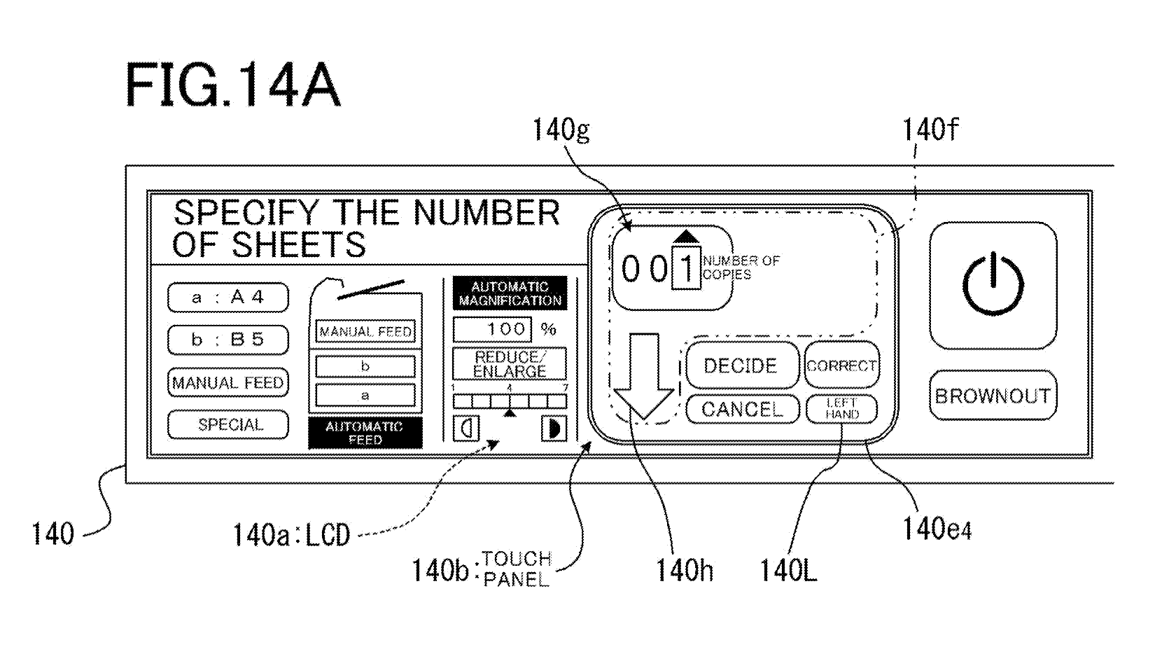

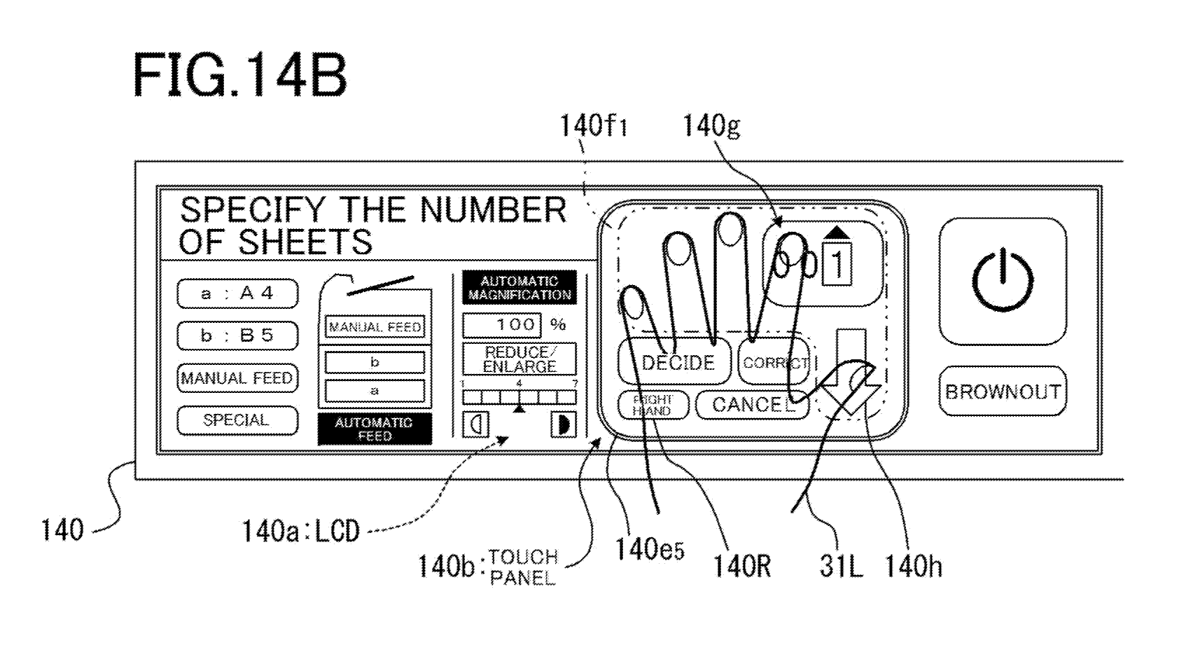

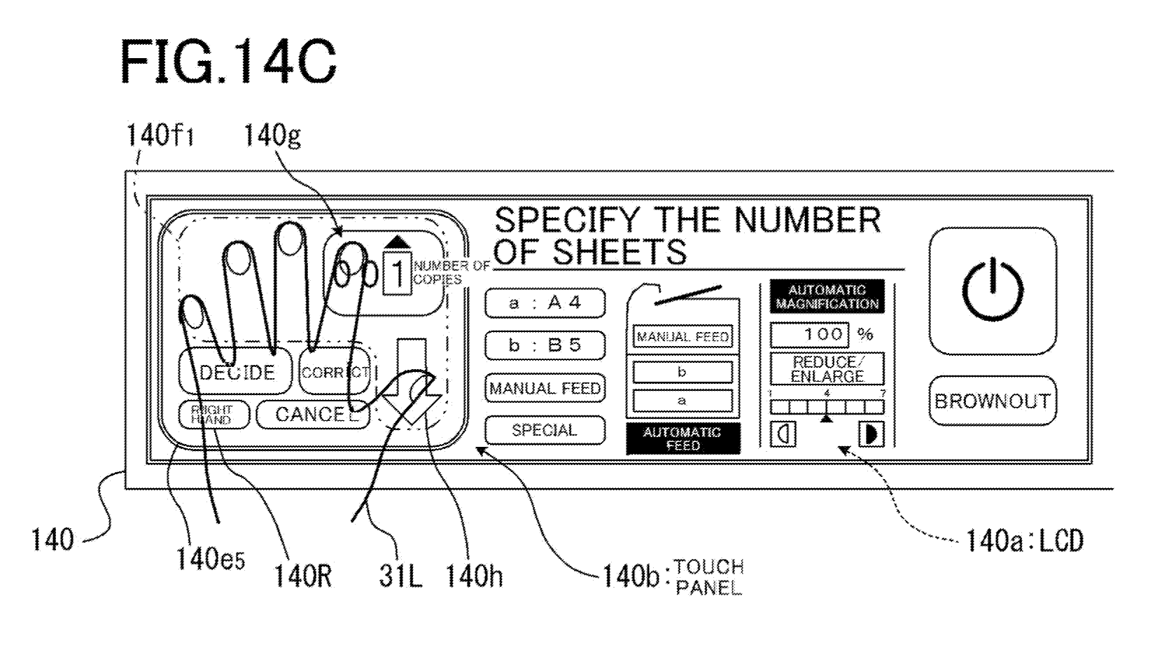

For example, as shown in FIG. 14A, there is provided a left-hand key 140L as a software key pad within the numeric input frame 140e4. Depressing this left-hand key 140L replaces the numeric input frame 140e4 with an input numeric input frame 140e5 (see FIG. 14B). The positions of numeric display part 140g, the display mark 140h and the like within the numeric input frame 140e5 is mirror image symmetric relative to those within the numeric input frame 140e4. In addition, the shape of the detection region 140f1 is mirror image symmetric relative to the detection region 140f, which allows for a left-hand operation.

Furthermore, when an appearance change is made from the numeric input frame 140e4 to the numeric input frame 140e5, as shown in FIG. 14c, the position at which the numeral input frame 140e5 is indicated may be shifted or moved to a position at a left side of both the LCD 140a and the touch panel 140b. The resulting arrangement will ease a left-hand operation.

It is to be noted that depressing a right-hand key 140R within the numeric input frame 140e5 will make an appearance change from the numeric input frame 140e5 to the numeric input frame 140e4. Thereby, the operation with the right hand 31R is again possible.

In each of the configurations that are provided by the above-described examples, tapping the portion of the numeric display part 140g is capable of increasing or decreasing the displayed numerical value. However, in the present disclosure, the portion to be tapped is not limited to the numeric display part 140g.

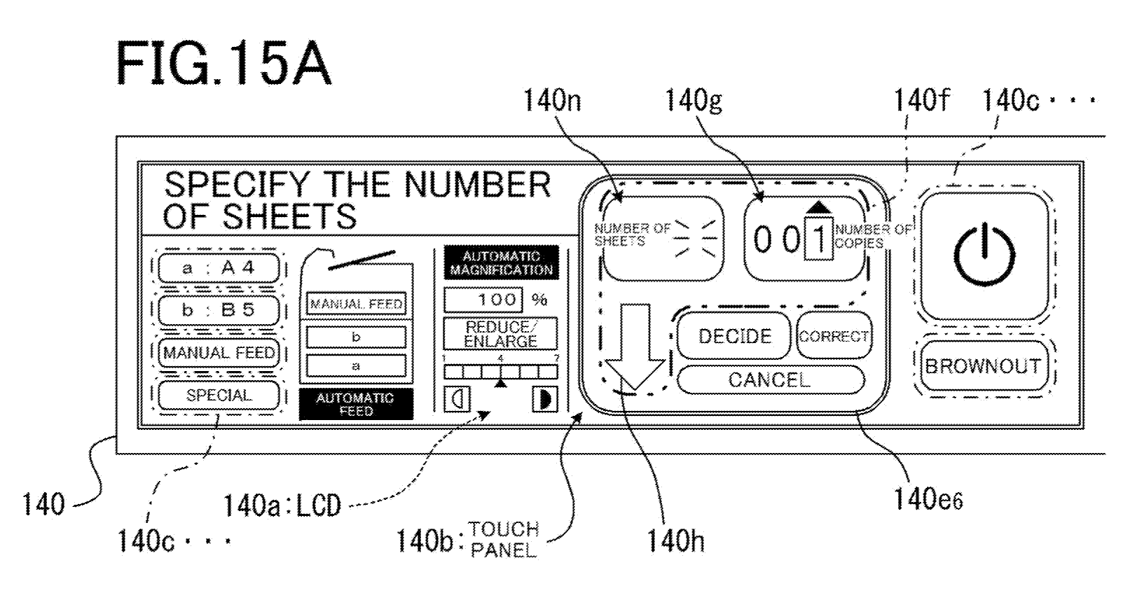

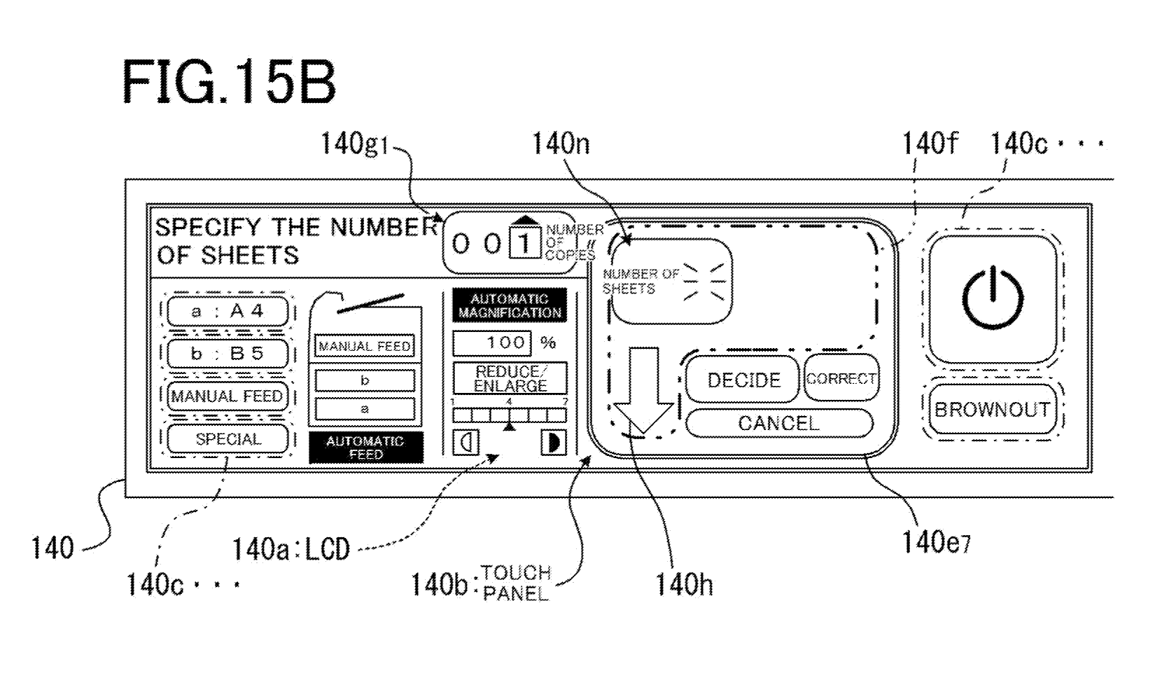

For example, as shown in FIG. 15A, there is provided a tapping part 140n in the vicinity of the numeric display part 140g within the numeric input frame 140e6. In such a configuration, the operation region 140f is identical with those that are illustrated in FIG. 3 to FIG. 5, which omits its description. According to the configuration shown in FIG. 15A, tapping the tapping part that is independent from the numerical display part will causes the numerical value to increase or decrease that is displayed on the numeric display part.

Moreover, as shown in FIG. 15B, it is possible to constitute an arrangement wherein the tapping part 140n is provided within the numeric input frame 140e7 and the numeric display part 140g1 is provided in the vicinity of an outside of the numeric input frame 140e7. The arrangements as shown in FIG. 15A and FIG. 15B allow the numerical value that appears on the numeric display part not to be concealed or covered by a finger at a tapping action.

In addition, in the exemplary embodiment of the present invention, an example shows detections regarding which portion of the detection region 140f-1 is depressed by the finger 31R-2 and how the depression condition is. On this respect, the detection region 140f-1 is available for detecting the position on which the finger 31R-3 depresses and the depression condition. However, in such a case, the detection region 140f-2 is requested to detect the positions on which the finger 31R-4 and the finger 31R-5 depress and the depression conditions.

In summary, in an image forming apparatus, an idea has been proposed that is free from having a hardware keyboard and a software keyboard.

For example, in a typical case, analyzing a signal issued from a compression sensor group that is made up of compression sensor arranged in a lattice form allows for counting the number of the compression sensors that are simultaneously. Then, this technology proposes to use the resulting or counted number as a numerical value to be inputted.

However, in the typical case as described above, arranging the compression sensors in the lattice form is requested. It is difficult to employ such a configuration. It is also to provide a region on a touch panel for input operation.

In view of the above-described circumstances, the present disclosure is established and its object is to provide an image forming apparatus and an input method, which are capable of inputting numerical values quickly and simply without having to have a hardware ten key pad or to switch an operation display part to a ten key display.

The present disclosure makes it possible to provide a numeric input only with a tapping action or a finger depression action on a touch panel. Thus, the present disclosure is capable of providing effects, without having to providing a hardware ten-key (numeric key board) or switching the display of the operation display part to a ten-key display, which include an achievement of inputting numerical values quickly and simply the like.

What is claimed is:

1. An operation display apparatus, comprising:
a display part that is configured to display, on a plane, various information pieces containing an indicated numerical value to be inputted;
a touch panel that is provided on a surface of the display part, the touch panel being configured to detect a position to which an operation such as a depression is performed for operating each of different plural operation points; and
a control part that is configured to receive a detection information piece from the touch panel and to output the various information pieces to the display part,
the control part counting the number of tapping actions as the indicated numerical value, each of the tapping actions being an operation on a first operation point within a first detection region provided on the touch panel.

2. The operation display apparatus according to claim 1, wherein the indicated numerical value has two or more digits, a second detection region is provided on the touch panel in the vicinity of the first detection region, the second detection region being configured to detect an operation that is executed to each of n second operation points, n being positive integer, and the control part counts the number of tapping actions at (n+1)th digit of the indicated numerical value.

3. The operation display apparatus according to claim 2, wherein the first operation point is operated by a second finger or a third finger of an operator's hand, each of the second operation points is operated by the third finger and its succeeding fingers of the operator or by a fourth finger and its succeeding finger, and
wherein the control part is configured to determine, in a case where a distance between the first operation point and one of the second operation points adjacent to the first operation point is within a specified first distance, that the first operation point and the second operation point are operated concurrently.

4. The operation display apparatus according to claim 1, wherein a third detection region is provided on the touch panel in the vicinity of both the first detection region and the second detection region, and
wherein the control part, in a case where the control part determines that no operation is executed on the third operation point, adds a specific value to the indicated numerical value every time the control part detects the tapping action on the first operation point, while the control part, and wherein the control part, in a case where the control part determines that an operation is made on the third operation point, adds a specific value to the indicated numerical value every time the control part detects the tapping action on the first operation point.

5. The operation display apparatus according to claim 4, wherein the first operation point is operated by the second finger of the operator's hand, the third operation point is operated by the first finger of the operator's hand, and the control part determines, in a case where a distance between the first operation point and the third operation point is within a specified second distance, that the first operation point and the third operation point are operated concurrently.

6. The operation display apparatus according to claim 1, further comprising an image read part that is configured to read an image data piece from an image manuscript, and an image forming part that is configured to carry out printing of an image material based on the image data piece, wherein the printing is repeated as many times as specified by the indicated numerical value.

7. An input method of an image forming apparatus, the image forming apparatus including a display part that is configured to display, on a plane, various information pieces containing an indicated numerical value to be inputted, and a touch panel that is provided on a surface of the display part, the touch panel being configured to detect a position on which an operation such as a depression is performed for each of different plural operation points,
the input method comprising the steps of;
counting the number of tapping actions as the indicated numerical value, each of the tapping actions being operation on a first operation point within a first detection region that is provided on the touch panel;
detecting n that the number of second operation points that are to be operated within a second detection region, the second detection region being provided on the touch panel in the vicinity of the first detection region;
counting the number of tapping actions at (n+1)th digit of the indicated numerical value;
detecting an operation on a third operation point within a third operation region, the third detection region being provided on the touch panel in the vicinity of the first detection region and in the vicinity of the second detection region;
causing, in a case while the third operation point is determined not to be operated, the indicated numerical value to add a specific value every time the tapping action on the first operation point is detected; and
causing, in a case while the third operation point is determined to be operated, the indicated numerical value to subtract a specific value every time the tapping action on the first operation point is detected.
